(19) United States
(12) Patent Application Publication
(10) Pub. No.: US 2009/0063205 A1
(43) Pub. Date: Mar. 5, 2009

(54) THEME PARK MANAGEMENT APPARATUS, THEME PARK MANAGEMENT METHOD, THEME PARK MANAGEMENT PROGRAM, AND RECORDING MEDIUM

(75) Inventor: Hiroaki Shibasaki, Tokyo (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 11/995,575

(22) PCT Filed: May 19, 2006
(86) PCT No.: PCT/JP2006/309992

§ 371 Date: Jan. 14, 2008

(30) Foreign Application Priority Data
Jul. 12, 2005 (JP) 2005-203623
Aug. 5, 2005 (JP) 2005-228843

(51) Int. Cl. G06Q 10/00

(52) U.S. Cl. 705/5

(57) ABSTRACT

A theme park management apparatus includes a receiving unit, a detecting unit, a generating unit, a determining unit, and a transmitting unit. The receiving unit receives information concerning a user specified attraction that is among plural attractions provided in a theme park. The detecting unit detects a congestion level for each of the attractions and the generating unit generates reservation information including a reservation time for the specified attraction. Based on the congestion level of each of the attractions, excluding the specified attraction, the determining unit determines a guidance point to which the user is guided and a privilege that becomes effective when the user follows guidance to the guidance point. The transmitting unit that transmits, to a communication terminal of the user, transmission information including the reservation information, the guidance point, and the privilege.

### TECHNICAL FIELD

The present invention relates to a theme park management apparatus, a theme park management method, a theme park management program, and recording medium. However, use of the present invention is not limited to the theme park management apparatus, the theme park management method, the theme park management program, and the recording medium.

### BACKGROUND ART

In a theme park, e.g., an amusement park, various events or amusement rides (hereinafter, “attractions”) are conventionally provided to users. A technology that references utilization information recording group utilization counts for attractions, the group being a group to which a theme park user belonged in the past, to extract attractions that are utilized least by the group and output information concerning the extracted attractions to a terminal device, to thereby efficiently provide, to the user, information introducing fresh attractions that are less used, is known (see, for example, Patent Document 1).

In a theme park, e.g., an amusement park, various events or amusement rides (hereinafter, “attractions” are conventionally provided to users. When utilizing the attractions, a significant wait-time occurs when there are crowds, such as during consecutive holidays or summer break, user satisfaction levels drop, and/or utilization of restaurants or souvenir stores decrease. To alleviate such a situation, a technology of making priority reservations for utilization of attractions is known.

An attraction priority reservation system that enables offering benefits to a user at the time of making attraction reservations based on consumption by the user in facilities and provides relevance between these consumption situations and the reservation system when, for example, at shops or restaurants in the facility, the user make large purchases or spends a significant amount eating and drinking at restaurants, has been proposed (see, for example, Patent Document 2).

Patent Document 1: Japanese Patent Application Laid-open No. 2004-295685

Patent Document 2: Japanese Patent Application Laid-open No. 2004-287879

### DISCLOSURE OF INVENTION

### Problem to be Solved by the Invention

However, for example, the conventional technology has a problem in that the drawing power of each attraction to draw customers cannot be adjusted. When a specific attraction has a high degree of drawing power, the wait-time during which visitors are standing in line for the attraction increases and satisfaction levels of the visitors drop. On the other hand, for an attraction having a low degree of drawing power, the rate of operation relative to operation capacity is low, which is not efficient for operation of the attraction.

An attraction having a high degree of drawing power is often an attraction that is widely talked about or very popular. Therefore, even if information concerning other attractions is simply provided, visitors are not likely to follow guidance, thus leading to a problem that providing the information hardly motivates users to move, for example.

The conventional technology also has a problem in that huge consumption on the part of the user is required to make a priority reservation, for example. In general, although amusements often involve high spending, financial burdens on users are increased when high spending is required for priority reservations, possibly resulting in a decrease in the number of times of the user utilizes the theme park itself.

There is also a problem in that users unfamiliar with utilization of the theme park do not make full use of priority reservations. For instance, even if a priority reservation is made, judging whether a user should stand in line for other attractions until the reservation time, i.e., determining whether use of an attraction the user stands in line to enter will finish by the reservation time is difficult. Therefore, for example, there is a problem in that making a priority reservation may stand in the way of enjoying various attractions.

### Means for Solving Problem

To solve the above problems and achieve an object a theme park management apparatus according to the invention of claim 1 includes a receiving unit that receives information concerning an attraction specified by a user (hereinafter, “specified attraction”) in a plurality of attractions provided in a theme park; a detecting unit that detects congestion levels of the attractions; a generating unit that generates reservation information having a reservation time of the specified attraction assigned therein when the receiving unit receives the information concerning the specified attraction; a determining unit that determines a guidance point where a user of the theme park is guided to and a privilege that becomes valid when the user follows guidance to the guidance point based on a detection result of the detecting unit targeting at least other attractions than the specified attraction having reservation information generated by the generating unit; and a transmitting unit that transmits transmission information including the reservation information generated by the generating unit and the guidance point and the privilege determined by the determining unit to a communication terminal of the user.

Further, a theme park management method according to the invention of claim 18 includes a receiving step of receiving information concerning an attraction specified by a user (hereinafter, “specified attraction”) in a plurality of attractions provided in a theme park; a detecting step of detecting congestion levels of the attractions; a generating step of generating reservation information having a reservation time of the specified attraction assigned therein when the receiving unit receives the information concerning the specified attraction; a determining step of determining a guidance point where a user of the theme park is guided to and a privilege that becomes valid when the user follows guidance to the guidance point based on a detection result of the detecting unit targeting at least other attractions than the specified attraction having reservation information generated by the generating unit; and a transmitting step of transmitting transmission information including the reservation information generated by the generating unit and the guidance point and the privilege determined by the determining unit to a communication terminal of the user.

Additionally, a theme park management program according to the invention of claim 19 causes a computer to execute the theme park management method according to claim 18.

Moreover, a computer-readable recording medium according to the invention of claim 1 store therein the theme park management program according to claim 19.

### BRIEF DESCRIPTION OF DRAWINGS

FIG. 1 is a block diagram of a functional structure of a theme park management system according to a first embodiment;

FIG. 2 is a flowchart of a processing procedure of the theme park management apparatus;

FIG. 3 is a layout of a theme park example according to Example 1;

FIG. 4 is a schematic of facilities in an attraction in the theme park;

FIG. 5 is a system configuration drawing of the theme park management system;

FIG. 6 is a block diagram of a hardware configuration of the theme park management apparatus;

FIG. 7 is a block diagram of a hardware configuration of a communication terminal;

FIG. 8 is an explanatory drawing of an attraction list;

FIG. 9 is a schematic of an attraction management file;

FIG. 10 is a schematic of a movement information file;

FIG. 11 is a schematic of an attraction utilization history file;

FIG. 12 is a schematic of a guidance/privilege information file;

FIG. 13 is a schematic of the guidance/privilege information file;

FIG. 14 is a schematic of an example of a method of calculating a current position from alternative GPS information;

FIG. 15 is a flowchart of a procedure of theme park management processing by the management apparatus;

FIG. 16 is a flowchart of a procedure of the theme park management processing by the management apparatus;

FIG. 17 is a view of an example of a display screen of transmission information;

FIG. 18 is a view of another example of the display screen of the transmission information;

FIG. 19 is a view of an example of a display screen when a reservation button in FIG. 18 is pressed;

FIG. 20 is a block diagram of a functional structure of the theme park management system according to a second embodiment;

FIG. 21 is a flowchart of a processing procedure executed by the theme park management apparatus;

FIG. 22 is a schematic of a user reservation number file;

FIG. 23 is a schematic of an attraction reservation number file;

FIG. 24 is a flowchart of a procedure of reservation processing for a reservation request;

FIG. 25 is a flowchart of a procedure of retrieval processing with respect to a request for adjusting available time in a reservation time slot;

FIG. 26 is a schematic of a display unit of the communication terminal when issuing a reservation request;

FIG. 27 is a schematic of the display unit of the communication terminal receiving reservation completion information; and

FIG. 28 is a schematic of the display unit of the communication terminal receiving an attraction retrieval result.

### EXPLANATIONS OF LETTERS OR NUMERALS

100 theme park management system
101 detecting unit
102 determining unit
103 transmitter
104 acquiring unit
104a input unit
104b detector
105 judging unit
106 searching unit
110 theme park management apparatus
120 communication terminal

### BEST MODE(S) FOR CARRYING OUT THE INVENTION

Exemplary embodiments of a theme park management apparatus, a theme park management method, a theme park management program, and a recording medium according to the present invention is explained in detail below with reference to the accompanying drawings.

### First Embodiment

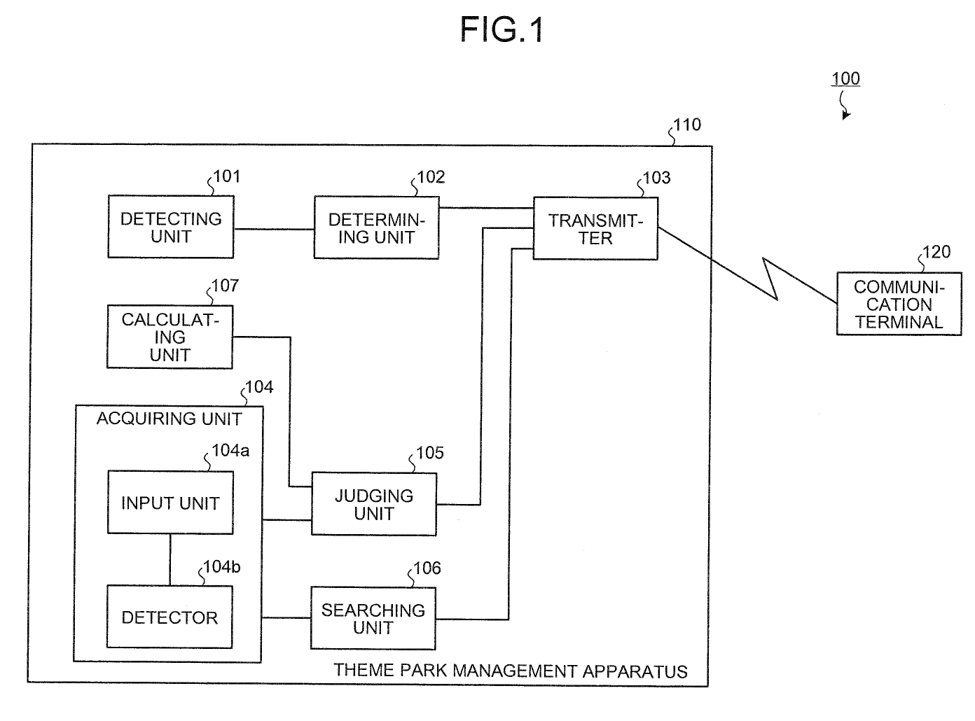

A functional structure of a theme park management system according to a first embodiment is first explained. FIG. 1 is a block diagram of a functional structure of the theme park management system according to the first embodiment.

As shown in FIG. 1, a theme park management system 100 includes a theme park management apparatus 110 and a communication terminal 120. The theme park management apparatus 110 manages, for example, congestion at each attraction of a theme park. Here, the theme park means an amusement facility having plural attractions on the premises thereof.

The attraction is a facility at, for example, an amusement park, a zoo, a restaurant, a movie theater, or a facility having an ability to draw customers according to a theme. In an amusement park, attractions include a roller coaster, a Ferris wheel, and others. The attraction may be an attraction that is appreciated by users or an attraction involving action on the part of the users, e.g., riding an amusement ride. The user means a person who visits the theme park, and more particularly, a person who carries the communication terminal 120. The user may be a single person or a group of plural users.

The communication terminal 120 means a portable computer terminal that can be carried by the user. The communication terminal 120 can perform communication with the theme park management apparatus 110 directly or indirectly via a gate device of each attraction. The communication terminal 120 may be lent by the theme park when, for example, the user enters the theme park, or may be a mobile phone owned by the user. One communication terminal 120 may be utilized by each user or by each group.

The theme park management apparatus 110 includes a detecting unit 101, a determining unit 102, a transmitter 103, an acquiring unit 104, a judging unit 105, a searching unit 106, and a calculating unit 107. The acquiring unit 104 includes an input unit 104a and a detector 104b.

The detecting unit 101 detects congestion levels of the attractions in the theme park. The congestion levels are calculated by, for example, counting the number of users standing in line for each attraction or calculating a wait-time from the number of available users per single operation of each attraction. The congestion level may be divided into, e.g., “high” and “low” levels in stages or may be represented by a continuous numerical value.

The determining unit 102 determines a guidance point that users of the theme park are guided to and privileges that become valid when the users follow the guidance toward the guidance point based on a detection result detected by the detecting unit 101. When the users are guided to a predetermined point in the theme park, distribution of the users in the theme park can be adjusted. The provision privileges that become valid when the users follow the guidance by the theme park management apparatus 110 can motivate the users, thereby increasing the probability that the guidance will be followed.

Specifically, the determining unit 102 determines, for example, an attraction whose congestion level detected by the detecting unit 101 is lower than a predetermined congestion level as the guidance point. The predetermined congestion level corresponds to, for example, a situation where the number of persons standing in line or a wait-time reaches a predetermined value. That is, in this case, the determining unit 102 guides the users to a relatively uncrowded attraction that is determined as the guidance point. The determining unit 102 determines, for example, a commercial facility in the theme park as the guidance point. The commercial facility in the theme park is, for example, a restaurant, a souvenir shop, or any other various specialty shops provided in the theme park.

The determining unit 102 determines a preferential treatment in the commercial facility relating to the theme park as a privilege. The facility relating to the theme park is, for example, not limited to a commercial facility in the theme park but may be a facility that can be expected to be utilized by the users of the theme park in conjunction with utilization of the theme park, such as, a parking lot of the theme park or a nearby accommodation facility. The privilege is, for example, a discount on the utilization fee in each facility or providing a free gift or exclusive merchandise. The determining unit 102 determines preferential treatment in an attraction whose congestion level is not lower than the predetermined congestion level as the privilege. The privilege in this case is, for example, making a priority reservation for utilization of the attraction, offering a discount on a utilization fee, or providing a free gift.

The determining unit 102 determines a valid period of the privilege. The valid period of the privilege is indicative of a period during which the privilege is valid. The determining unit 102 determines the valid period of the privilege within a predetermined time after a later-explained transmitter 103 transmits transmission information to the communication terminal 120 of the user.

The transmitter 103 transmits the transmission information including the guidance point and the privilege determined by the determining unit 102 to the communication terminal 120 of the user. The transmitter 103 transmits the transmission information to all the users in the theme park and also transmits the transmission information to the users standing in line for an attraction having a congestion level that is not lower than the predetermined congestion level, for example. The transmission information is also transmitted to, for example, the users moving toward an attraction having a congestion level that is not lower than the predetermined congestion level as a destination.

The acquiring unit 104 acquires current position information of the communication terminal 120 of the user. The acquiring unit 104 includes the input unit 104a and the detector 104b. The input unit 104a accepts input of identification information of the communication terminal 120 received from the communication terminal 120 by plural communicators (not shown) installed in the theme park. The input unit 104a may further accept transmission time information of the identification information from the communication terminal 120 received from the communication terminal 120 by the communicators.

Here, the identification information is, for example, an ID number of the communication terminal 120. Because the transmission time of the identification information differs depending on the current position during movement even if the same communication terminal 120 is used, the transmission time information may be included in the identification information when transmitting the identification information. The transmission time information is specifically, for example, a transmission clock time itself. As a result, the communicators that receive the identification information can grasp whether the information is the identification information transmitted from the communication terminal 120 at that moment, thus improving accuracy in detecting a current position.

Likewise, as the transmission time information, a code indicative of a transmission clock time may be added to the end of the ID number that is the identification information. Based on the added coded, the communicators that receive the identification information can grasp whether the information is the identification information transmitted from the communication terminal 120 at that moment, thereby improving accuracy in detecting a current position. Likewise, when transmitting the identification information, the transmission time information may be included in the identification information to be transmitted.

The detector 104b detects a reception clock time in each communicator for each piece of identification information acquired by the input unit 104a. The reception clock time in each communicator may be, for example, a time of receiving the identification information in each transmitter as well as a time required until the identification information is received by each communicator after transmission from the communication terminal 120.

The acquiring unit 104 calculates current position information of the communication terminal 120 in a region based on position information of each communicator and a detection result detected by the detector 104b. The acquiring unit 104 uses, for example, a difference between clock times when receiving the identification information of the communication terminal 120 by the respective communicators to calculate a relative distance from each communicator to the communication terminal 120. The acquiring unit 104 further uses the position information of each communicator to detect the current position information of the communication terminal 120 in the region. The acquiring unit 104 may calculate the current position information of the communication terminal 120 in the region based on the transmission time information input by the input unit 104a.

When the communication terminal 120 uses, for example, GPS information to acquire the current position information itself, the current position information may be acquired by receiving the current position information from the communication terminal 120. The acquiring unit 104 may acquire the current position information of all the users in the theme park or may acquire the current position information of a specific user, e.g., a user in a predetermined area from an attraction.

The judging unit 105 judges whether the users are standing in line for an attraction having a congestion level at or above the predetermined congestion level based on the current position information acquired by the acquiring unit 104. For example, when the current position of a user is in a predetermined area from an attraction having a congestion level at or above the predetermined congestion level, the judging unit 105 determines that the user is standing in line for this attraction. The judging unit 105 may determine that a user is standing in line only when he/she remain in the area for a predetermined time or more to discriminate the user from other users just passing through the area. For example, whether a user is standing in line may be judged by making a judgment upon whether a current position of the user is in a path (hereinafter, “waiting path for entrance”) that users waiting to enter an attraction are guided to.

Additionally, the current position of the user can be also acquired by communication between an entrance gate device and the communication terminal 120 to obtain the identification information when the user passes the entrance gate device of each attraction, for example. In this case, the location of the attraction that the user enters is the current position of the user, and information including information indicative of this current position and the identification information is the current position information.

In this case, the number of users in line waiting for entrance can be judged from the timing (e.g., a clock time or an order) of acquiring the identification information. In this case, communication is performed between a gate device for exit and the communication terminal 120 and the acquired identification information is used to specify the user exiting the attraction. Specifically, the user in the attraction and his/her entrance order are specified from the identification information obtained by the gate devices for entrance and exit. A full capacity number is subtracted from the user having a smaller number in the waiting line to determine that the users after that user are waiting for entrance.

The searching unit 106 uses the current position information acquired by the acquiring unit 104 to search for a path from the current position of the communication terminal 120 to the guidance point. The searching unit 106 uses, for example, a path search algorithm like a Dijkstra method to search for a path from the current position to the guidance point. When the searching unit 106 successfully finds a path, the transmitter 103 transmits transmission information including the path found by the searching unit 106 to the communication terminal 120.

The calculating unit 107 calculates, based on the current position information acquired by the acquiring unit 104, a wait-time until the user can enter the attraction that the user is waiting to enter. The calculating unit 107 also calculates, based on the current position information acquired by the acquiring unit 104, the number of persons waiting ahead of the user at the attraction.

When the calculating unit 107 calculates the wait-time or the number of persons waiting, the judging unit 105 judges whether the wait-time or the number of persons waiting is not smaller than a predetermined time or a predetermined number of persons. The transmitter 103 transmits the transmission information to the communication terminal 120 of the user based on a judgment result of the judging unit 105. Specifically, for example, the judging unit 105 transmits the transmission information to the communication terminal 120 of the user having a wait-time that is not smaller than the predetermined time alone. Alternatively, the judging unit 105 transmits the transmission information to the communication terminal 120 of the user having the number of users waiting that is not smaller than the predetermined number of persons waiting alone.

Here, the number of persons waiting is the number of users forming an entrance waiting line at an attraction (hereinafter, “ordinary persons”), but the number of users having made reservations for use of this attraction (hereinafter, “reservation holders”) may be included in addition to the former number. The number of ordinary persons can be calculated from, for example, the current position of the user. Specifically, for example, users positioned between the entrance gate of the attraction that the user is waiting to enter and the current position of the user as a calculation target are calculated as the number of ordinary persons.

Additionally, the ordinary persons can be determined from the identification information acquired at the gate devices for entrance and exit and a timing (e.g., a clock time or an order) of acquiring the identification information. Specifically, of the users determined to be waiting for entrance, users specified based on the identification information acquired at a timing earlier than that of the identification information of the user as a calculation target are ordinary persons.

The number of reservation holders can be specifically acquired by, for example, providing a table storing the number of reservation holders for each attraction and making reference to the table when detecting the number of persons waiting. In this case, the table is updated periodically, e.g., at 10-minute intervals. The number of ordinary persons or reservation holders is counted with consideration of the number of persons constituting each group in an operational configuration where the single communication terminal 120 is provided to each group.

The wait-time can be calculated based on, e.g., the number of persons waiting who are waiting to enter before the user as a wait-time calculation target. When using the number of persons waiting to calculate the wait-time, the wait-time can be calculated by, for example, dividing the number of persons waiting by the number of persons at full capacity per operation and multiplying the obtained value by the time required for utilization of the attraction.

When using the number of persons waiting to calculate the wait-time, the wait-time can be calculated by, for example, dividing the number of persons waiting by the number of persons at full capacity and multiplying the integer part of the obtained value by a required time. Here, the integer part of the value obtained by dividing the number of persons waiting by the number of persons at full capacity is indicative of the number of times that the attraction is operated until the user can enter. It is to be noted that the wait-time may include the time until an event in the currently operated attraction is finished.

The wait-time can be calculated based on, for example, a distance from the entrance gate of the attraction that the user is waiting to enter to the current position of the user (hereinafter, “waiting line distance”). In this case, although a position of the entrance gate of the attraction the user is waiting to enter is already known, a current position of the user is appropriately calculated. Specifically, the waiting line distance is a linear distance from the entrance gate of the attraction the user is waiting to enter to the current position of the user when a waiting path for entrance has a linear shape, and it is a distance with meandering taken into consideration when the waiting path for entrance has a meandering shape. When a file storing a shape or a length of the waiting path for entrance is provided and a current position of the user in the waiting path for entrance is specified, the waiting line distance can be calculated irrespective of a shape of the waiting line for entrance.

When using the waiting line distance to calculate a wait-time, the wait-time is calculated by multiplying a wait-time per unit distance by the waiting line distance. Here, the wait-time per unit distance is the time required for the user waiting for entrance to advance the unit distance. The wait-time per unit distance is a value preset by a theme park manager. The wait-time per unit distance is set according to the number of persons at full capacity per operation of each attraction, a required time, or a shape of the waiting path for entrance.

The wait-time per unit distance is set to, for example, a shorter time when the number of persons at full capacity per operation of an attraction is increased. The wait-time per unit distance is set to, for example, a longer time when a required time is increased. The wait-time per unit distance is set to a longer time when a shape of the waiting path for entrance is complicated, such as, when the path has steps like stairs or is meandering as compared with a flat linear path. As a specific example of calculation of the wait-time using the waiting line distance, when the wait-time per unit distance is 2 minutes/meter and the waiting line distance is 10 meters, 2×10=20 minutes is calculated as a wait-time for entrance.

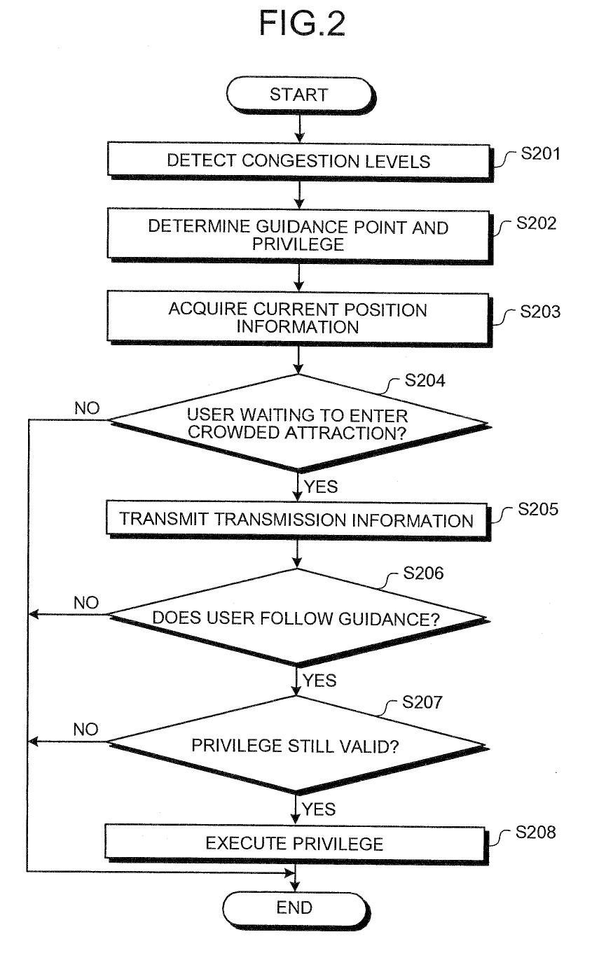

Processing executed by the theme park management apparatus 110 will now be explained. FIG. 2 is a flowchart of a processing procedure of the theme park management apparatus. In this flowchart, an example where transmission information is transmitted to a user waiting to enter an attraction having a congestion level at or above a predetermined congestion level (crowded attraction) will be explained.

First, the theme park management apparatus 110 uses the detecting unit 101 to detect congestion levels of the attractions provided in the theme park (step S201). Then, the determining unit 102 determines a guidance point that a user is guided to and a privilege based on a detection result of the detecting unit 101 (step S202). Subsequently, the acquiring unit 104 acquires current position information of the user (step S203). The judging unit 105 judges whether the user whose current position information is acquired at step S203 is waiting to enter the crowded attraction (step S204).

When the user is waiting to enter the crowded attraction (step S204: YES), transmission information is transmitted to the communication terminal 120 of the user (step S205). The searching unit 106 may search for a path from the current position to the guidance point and path information may be included in the transmission information. On the other hand, when the user is not waiting to enter the crowded attraction (step S204: NO), the transmission information is not transmitted, and processing based on this flowchart is terminated.

When the transmission information is transmitted at step S205, the theme park management apparatus 110 judges whether the user is following the guidance to the guidance point (step S206) to judge whether the privilege becomes valid, and specifically whether the user agrees to follow the guidance to the guidance point or whether the user utilizes the guidance point is authenticated. When the user follows the guidance to the guidance point (step S206: YES), whether the privilege is still valid is further judged (step S207).

When the privilege is still valid (step S207: YES), the privilege for the user is executed (step S208), and the processing based on this flowchart is terminated. On the other hand, when the user does not follow the guidance to the guidance point (step S206: NO), or when the privilege has expired (step S207: NO), the processing based on this flowchart is terminated. The judgments at steps S206 and S207 may be made by an employee of a facility where the privilege can be realized (e.g., a sales assistant in a commercial facility).

As explained above, in the theme park management system 100 according to the first embodiment, transmitting the transmission information including the guidance point and the privilege determined based on the congestion level of an attraction enables urging the user to move in the theme park, thereby preventing the users from being concentrated at specific attractions. When an attraction having a congestion level lower than the predetermined congestion level is determined as the guidance point, the users can be dispersed from attractions with high congestion levels, or capacity operating rates of attractions with low capacity operation rates can be improved. When a commercial facility in the theme park is determined as the guidance point, the congestion levels of the attractions can be adjusted.

When the privilege that becomes valid when the user follows the guidance is determined as a preferential treatment in commercial facilities or at attractions having congestion levels at or above the predetermined congestion level, the probability that each user follows the guidance by the theme park management apparatus 110 can be increased. When a valid period is provided concerning the privilege, each user can be motivated to move rapidly.

Transmission of the transmission information to the users who are waiting to enter an attraction having a congestion level at or above the predetermined congestion level or moving toward such an attraction as a destination enables dispersing the users from the attraction having the high congestion level. Searching for a path from an actual location of the user to the guidance point and transmitting the found path to the communication terminal allows the user to accurately navigate to the guidance point.

### EXAMPLE 1

### Entire Structure of Theme Park Management System

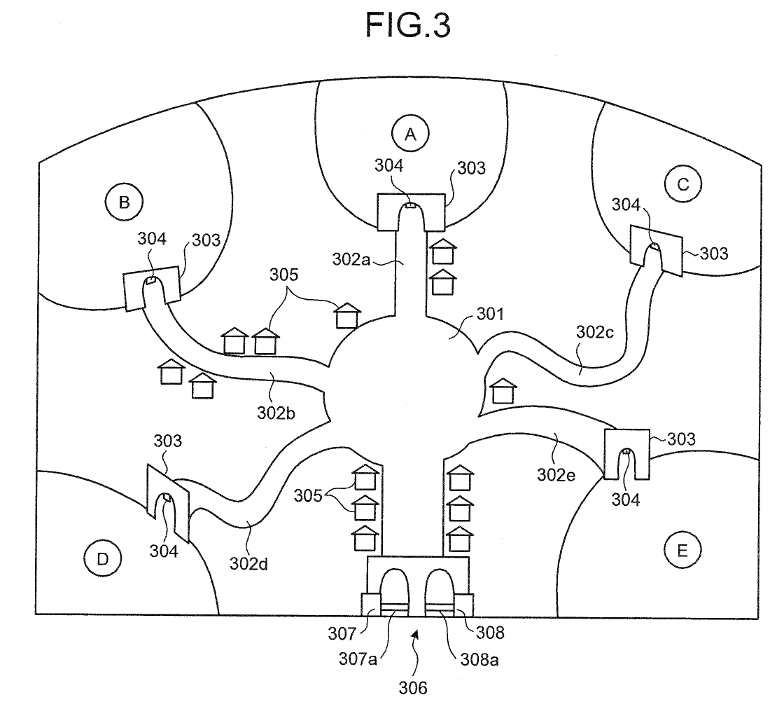

Example 1 of the theme park management apparatus 110 according to the first embodiment will now be explained. FIG. 3 is a layout of a theme park example according to Example 1. In the theme park depicted in FIG. 3, plural attractions A to E are provided. A plaza 301 is provided at the center of the premises of the theme park, and plural paths 302a to 302e leading to the respective attractions A to E extend from the plaza 301. Passage gates 303 leading to the respective attractions A to E are provided beyond the respective paths 302a to 302e from the plaza 301. The respective passage gates 303 are provided at positions where users pass to use the respective attractions A to E.

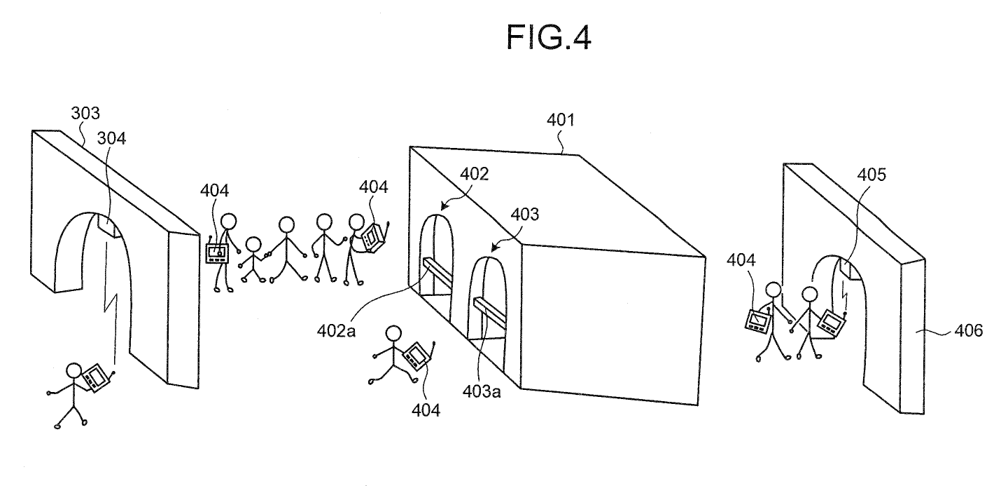

A communicator 304 is provided at each passage gate 303. Each communicator 304 receives, from the communication terminal, identification information that identifies the communication terminal (see FIG. 4) of a user waiting to enter the respective attractions A to E. In Example 1, a user ID is used as the identification information. As the user ID, a name, contact information, gender, age, a number of an account settling card, etc. of the user may be used.

Here, in Example 1, a situation where a group of persons carries a single communication terminal is assumed. The communication terminal is not limited to a group of persons carrying a single communication terminal, and each user may carry a communication terminal.

Specification information that specifies correspondence between each communicator and each attraction is assigned to each communicator 304. Position information indicative of a position of each corresponding attraction may be assigned to each communicator 304. In this case, specifying the communicator 304 receiving the identification information from the communication terminal allows the later-explained management apparatus to specify each communication terminal (i.e., an individual user or a group) and the current position thereof in the theme park.

Various shops 305, e.g., souvenir shops or restaurants are also provided in the theme park. A park entrance gate device 307 and a park exit gate device 308 are provided at an entrance/exit of the theme park denoted by reference numeral 306 in FIG. 3.

The park entrance gate device 307 and the park exit gate device 308 include crossing bars 307a and 308a, respectively. The park entrance gate device 307 detects a user who enters (is going to enter) the theme park, and operates and controls the crossing bar 307a based on a detection result. The park exit gate device 308 detects a user who exits (is going to exit) the theme park, and operates and controls the crossing bar 308a based on a detection result.

When the park entrance gate device 307 detects a user who is going to enter the theme park, the park entrance gate device 307 judges whether the user has a passport or a ticket for entrance, and operates and controls the crossing bar 307a according to the judgment result. Whether the user has an entrance ticket can be judged by providing a storage medium, e.g., an IC chip or a magnetic tape to the entrance ticket and using a dedicated reader to read data stored in the storage medium. Additionally, for example, an employee of the theme park may judge whether each user has an entrance ticket to manually open/close the crossing bar 307a.

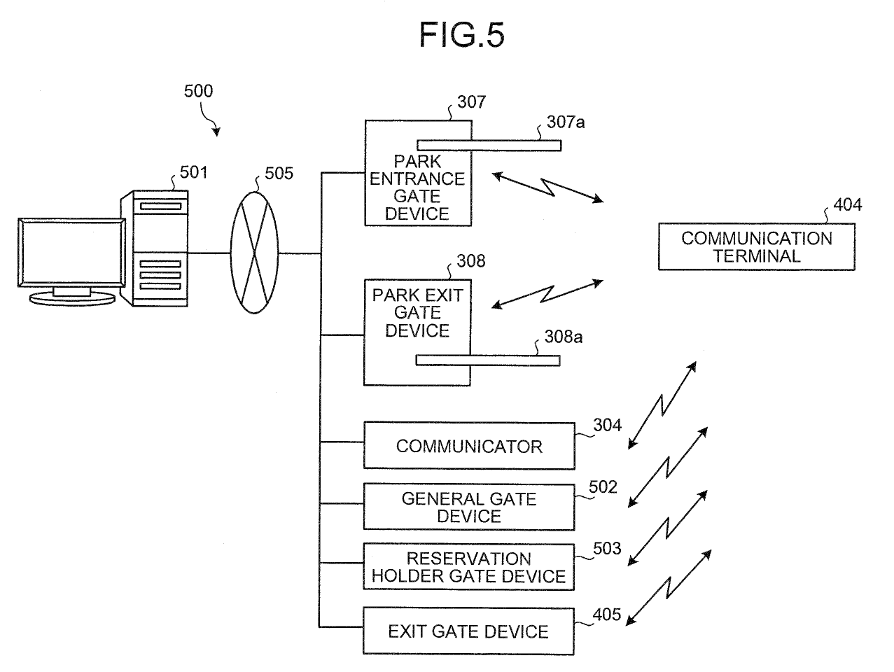

The park entrance gate device 307 outputs information concerning each user entering the theme park to a later-explained theme park management apparatus (see FIG. 5) each time the crossing bar 307a is operated. Likewise, the park exit gate device 308 outputs information concerning each user exiting the theme park to the theme park management apparatus each time the crossing bar 308a is operated and controlled. The information concerning each user entering the theme park or exiting the theme park may be the user ID received from the communication terminal of the user or information simply indicative of the presence/absence of a user entering the theme park or exiting the theme park.

Facilities in each attraction in the theme park will now be explained. FIG. 4 is a schematic of facilities in an attraction in the theme park. FIG. 4 depicts an example of facilities in a single attraction to be explained, but the same facilities are provided in all the attractions in the theme park. A general entrance gate 402 and a reservation holder entrance gate 403 for entering the attraction 401 are provided for the attraction 401.

The user enters the attraction 401 through one of the general entrance gate 402 or the reservation holder entrance gate 403 according to presence or absence of a reservation concerning the corresponding attraction. Although a special drawing is omitted, a waiting path for entrance where users waiting to enter the attraction is led to the general entrance gate 402. Various elaborate shapes of the waiting path for entrance, e.g., an undulating path having a slope or stairs or a meandering path like a labyrinth are assumed according to each attraction, and the shapes are not restricted. A distance of the waiting path for entrance is not a planar distance but a stereoscopic distance along which each user actually moves. An example of a linear waiting path for entrance will be explained in Example 1.

The general entrance gate 402 is not an entrance for, for example, boarding to actually utilize the attraction, and may be provided at a position away from this entrance by a predetermined distance. In this case, a route from the general entrance gate 402 to the entrance is the waiting path for entrance. A distance of the waiting path for entrance in this case is not a planar distance but a stereoscopic distance including undulations, e.g., a slope or stairs.

A general gate device and a registered user gate device (see FIG. 5) that judge whether utilization of the attraction 401 is possible and include crossing bars 402a and 403a operated and controlled to permit or restrict entrance to the attraction 401 are provided at the general entrance gate 402 and the reservation holder entrance gate 403, respectively. Whether utilization of the attraction 401 is possible is judged based on a result of communication between these devices and the communication terminal 404 of the user. In this case, each communication terminal 404 includes information indicative of whether utilization of the attraction 401 is possible in association with the user ID.

When a number of the account settling card can be received as the identification information concerning the user, whether the attraction 401 can be used may be judged based on whether the number of the account settling card is received. As the judgment upon whether the attraction 401 can be used, an employee, etc. of the theme park may judge whether the user has a passport or a ticket for utilization of the attraction 401.

The reservation holder gate device judges whether a reservation for use of the corresponding attraction 401 has been made, and operates and controls the crossing bar 403a to permit or restrict entrance to the attraction 401 based on a result of the judgment. The general gate device and the reserved person gate device output information indicating that the user enters the attraction 401 to the theme park management apparatus when the user passes through the general entrance gate 402 or the reservation holder entrance gate 403.

An exit gate 406 including an exit gate device 405 that detects a user exiting the attraction 401 after use of the attraction 401 is provided at the attraction 401. The exit gate device 405 performs communication with the communication terminals 404 carried by users to specify a user utilizing the attraction 401, and also outputs information indicating that the user has utilized the attraction 401 to the theme park management apparatus.

A system configuration of the theme park management system will now be explained. FIG. 5 is a system configuration drawing of the theme park management system. As shown in FIG. 5, in a theme park management system 500, a management apparatus 501, the park entrance gate device 307 depicted in FIG. 3, the crossing bar 307a, the park exit gate device 308, the crossing bar 308a, the communicator 304, the exit gate device 405 depicted in FIG. 4, the general gate device 502, and the reservation holder gate device 503 are connected to each other through a network 505.

The management apparatus 501 is a server that performs communication with the park entrance gate device 307, the park exit gate device 308, the communicator 304, the exit gate device 405, the general gate device 502, and the reservation holder gate device 503 through the network 505. Communication between the respective devices in the theme park management system is carried out wirelessly or through a communication cable. The management apparatus 501 calculates an expected wait-time or sets a congestion level for each attraction 401, for example.

### Hardware Configuration of Management Apparatus

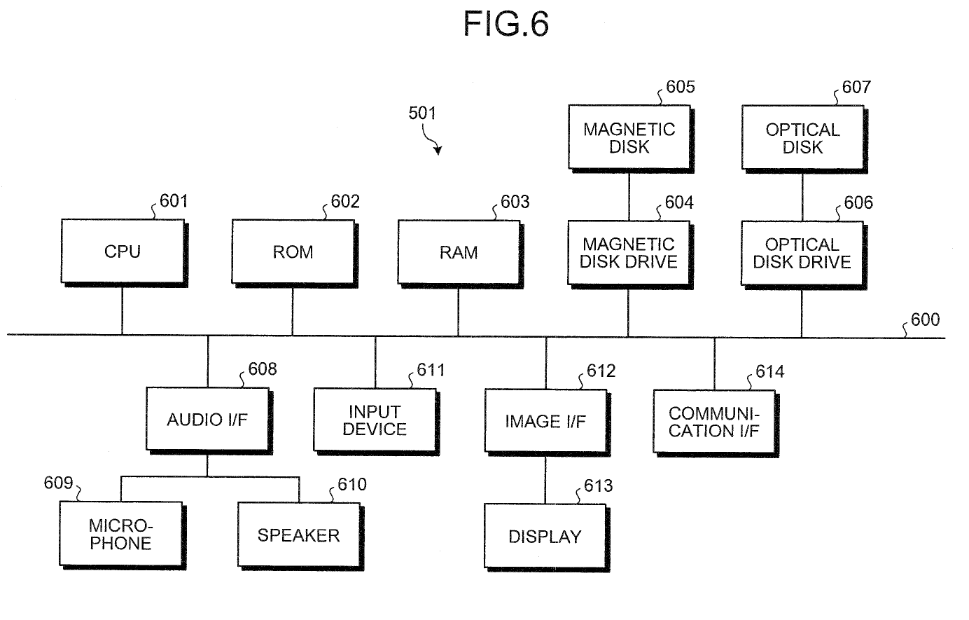

A hardware configuration of the management apparatus 501 will now be explained. FIG. 6 is a block diagram of a hardware configuration of the theme park management apparatus. As shown in FIG. 6, the management apparatus 501 includes a CPU (Central Processing Unit) 601, an ROM (Read Only Memory) 602, an RAM (Random Access Memory) 603, a magnetic disk drive 604, a magnetic disk 605, an optical disk drive 606, an optical disk 607, an audio I/F (interface) 608, a microphone 609, a speaker 610, an input device 611, a image I/F 612, a display 613, and a communication I/F (interface) 614. The respective constituent units 601 to 614 are connected with each other through a bus 600.

Here, the CPU 601 controls the entire management apparatus 501. The ROM 602 stores a program, e.g., a boot program. The ROM 603 is used as a work area for the CPU 601.

The magnetic disk drive 604 controls reading/writing data from/onto the magnetic disk 605 under the control of the CPU 601. The magnetic disk 605 stores data written under the control of the magnetic disk drive 604. As the magnetic disk 605, an HD (Hard Disk) or an FD (Frekisible Disk) can be used, for example.

The optical disk drive 606 controls reading/writing data from/onto the optical disk 607 under the control of the CPU 601. The optical disk 607 is a recording medium from which data is read out under the control of the optical disk drive 606 and is detachable from the optical disk drive 606. As the optical disk 607, a writable recording medium can be utilized. A recording medium that is detachable from the optical disk drive 606 may be an MO (Magnet-Optical disk) or a memory card as well as the optical disk 607.

When using the MO or the memory card as the detachable recording medium, a drive device that can read data from each recording medium is provided in place of or in addition to the optical disk drive 606. A theme park management program is recorded on the optical disk 607 according to Example 1. The theme park management program is not limited to one recorded in the optical disk 607.

The audio I/F 608 is connected with the audio input microphone 609 and the audio output speaker 610. Audio received by the microphone 609 is subjected to A/D conversion in the audio I/F 608. The speaker 610 outputs audio. As the input device 611, there are, for example, a remote controller, a keyboard, a mouse, or a touch panel that includes plural keys for inputting characters, numerical values, various instructions, etc.

The display 613 is connected with the image I/F 612. The image I/F 612 specifically includes, for example, a graphic controller that controls the entire display 613, a buffer memory such as a VRAM (Video RAM) that temporarily stores image information that can be instantaneously displayed, a control IC that performs display control of the display 613 based on image data output from the graphic controller, and others.

The display 613 displays various kinds of data, e.g., an icon, a cursor, a menu, a window, a character, or an image. For example, a CRT, a TFT, a liquid crystal display, or a plasma display can be adopted as the display 613.

When communicating with the park entrance gate device 307, the park exit gate device 308, the communicator 304, the park exit gate device 405, the general gate device 502, and the reservation holder gate device 503, the communication I/F 614 functions as an interface with these respective devices and the CPU 601. When performing communication between each device and the CPU 601 through the communication I/F 614, a dedicated network may be used, or a general-purpose network may be used. In this case, there are an LAN, a WAN, a public line network, a mobile phone network, and others as the network. The communication I/F 614 performs communication with the communication terminal 404 via the park entrance gate device 307, the park exit gate device 308, the communicator 304, the exit gate device 405, the general gate device 502, and the reservation holder gate device 503.

The detecting unit 101, the determining unit 102, the transmitter 103, the acquiring unit 104, the judging unit 105, and the searching unit 106 depicted in FIG. 1 are realized when the CPU 601 executes a program stored in the ROM 602 or the RAM 603, the magnetic disk 605, or the optical disk 607 in the management apparatus 501 or when communication is effected through the communication I/F 614.

### Hardware Configuration of Communication Terminal

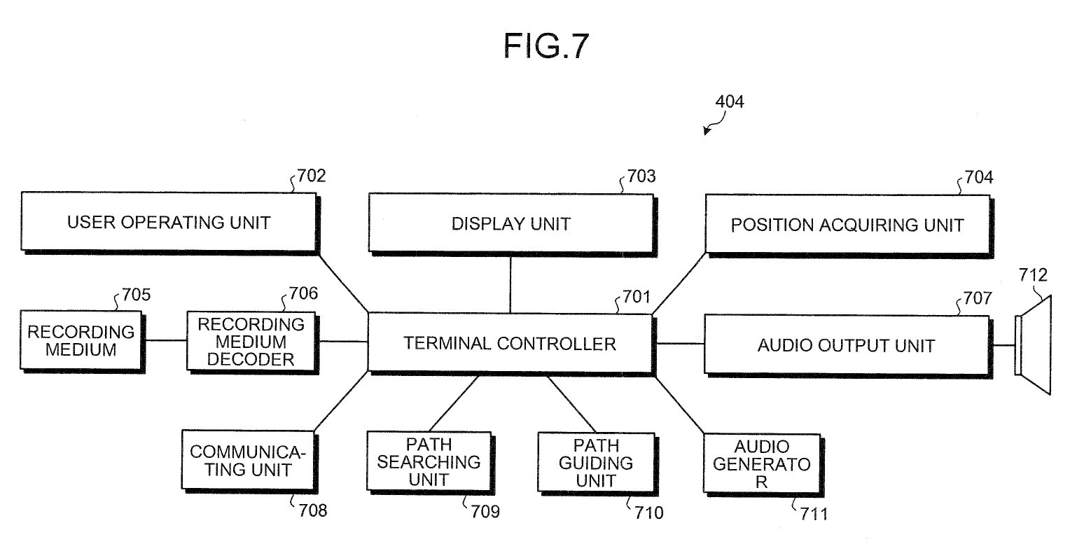

A hardware configuration of the communication terminal 404 will now be explained. FIG. 7 is a block diagram of a hardware configuration of the communication terminal. As shown in FIG. 7, the communication terminal 404 includes a terminal controller 701, a user operating unit 702, a display unit 703, a position acquiring unit 704, a recording medium 705, a recording medium decoder 706, an audio output unit 707, a communicating unit 708, a path searching unit 709, a path guiding unit 710, an audio generator 711, and a speaker 712.

The terminal controller 701 controls the entire communication terminal 404. The terminal controller 701 can be realized by, for example, a microcomputer including a CPU that executes a predetermined arithmetic processing, an ROM that stores various control programs, or an RAM that functions as a work area for the CPU. The ROM or the RAM records identification information that identifies each communication terminal 404. The terminal controller 701 also inputs/outputs information from/to the management apparatus 501 via the communicating unit 708 at the time of path guidance, and outputs information obtained as a result of this input/output to the display unit 703 and the audio output unit 707.

The user operating unit 702 outputs information, e.g., a character, a numerical value, or various instructions input by a user carrying the communication terminal 404 to the terminal controller 701. As a structure of the user operating unit 702, various kinds of known configurations, e.g., a push button that detects a physical pushing/non-pushing manipulation, a touch panel, a keyboard, or a joystick can be adopted. The user operating unit 702 may use a microphone that inputs external sound to perform an input operation based on the sound.

The user operating unit 702 may have any one of the various configurations, or may have plural configurations, e.g., the touch panel and the push button. A user appropriately performs an input operation according to the configuration of the user operating unit 702 to input information. As the information input by the operation of the user operating unit 702, for example, there are a response to transmission information transmitted from the management apparatus 501, information concerning an attraction to be used, and others.

The information concerning an attraction to be used is input by, for example, displaying a list of the attractions 401 in the theme park in the display unit 703 and allowing a user to specify an attraction 401 from the displayed list. The attraction 401 to be used may be also input by specifying a genre or a keyword of the attraction 401 to be used and searching for the corresponding attraction 401 based on this specification. The attraction 401 to be used may be also input by displaying a map of the theme park in the display unit 703 having a touch panel superimposed thereon and specifying a point on the displayed map.

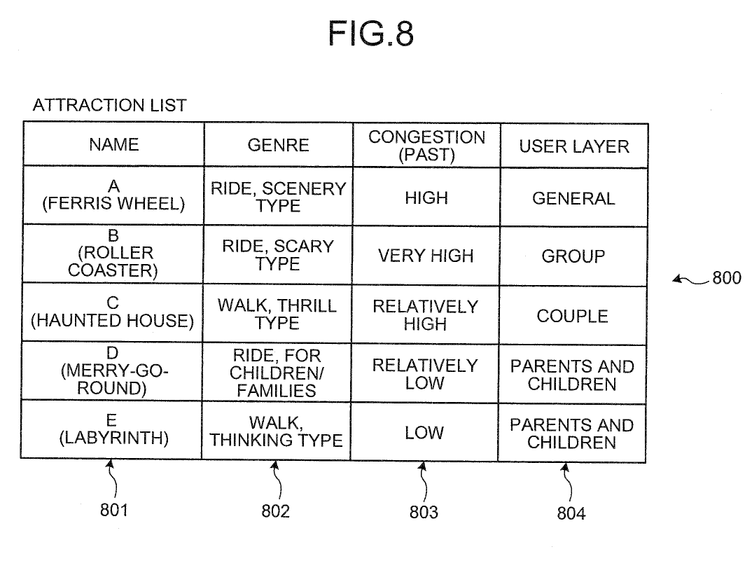

When the information of the attraction 401 to be used is input, the terminal controller 701 specifies a position of the attraction 401 based on a latitude/longitude of a point where the corresponding attraction 401 is located. More specifically, information of, for example, the latitude/longitude of the point where the corresponding attraction 401 is located is specified as one point on the map based on background classification data included in map information recorded in the recording medium 705. The information, e.g., the latitude/longitude of the point where the corresponding attraction 401 is located may be directly acquired from a later-explained attraction list (see FIG. 8) by referencing this attraction list.

The display unit 703 includes, for example, a CRT (Cathode Ray Tube), a TFT liquid crystal display, an organic EL display, a plasma display, and others. Specifically, the display unit 703 may be formed of, for example, the image I/F or a graphic display device connected with the image I/F.

Specifically, the image I/F includes, e.g., a graphic controller that controls the entire display device, a buffer memory such as a VRAM (Video RAM) that temporarily stores image information that can be instantaneously displayed, a control IC that controls display of the display device based on the image information output from the graphic controller, and others. The display unit 703 displays various kinds of information, e.g., an icon, a cursor, a menu, a window, a character, or an image. The display unit 703 also displays map information stored in the storage medium 705 or information concerning path guidance.

The position acquiring unit 704 is formed of, for example, a GPS receiver, and acquires information concerning a current position of each communication terminal 404. The GPS receiver receives radio waves from a GPS satellite to obtain a geometrical position with respect to the GPS satellite. GPS stands for Global Positioning System and is a system that receives radio waves from four or more satellites to accurately obtain a ground position. The GPS receiver is formed of an antenna that receives radio waves from the GPS satellite, a tuner that demodulates the received radio waves, an arithmetic circuit that calculates a current position based on the demodulated information, and others. Although particulars will be explained hereinafter, it is to be noted that a position of the communication terminal 404 can be specified based on information supplied from the communicator 304 provided in the theme park even if the position acquiring unit 704 is not provided.

The recording medium 705 records various kinds of control programs or various kinds of information in a computer-readable format. The recording medium 705 accepts writing information by the recording medium decoder 706 and records the written information in a non-volatile manner. The recording medium 705 can be realized by, for example, an HD.

The recording medium 705 is not limited to an HD, and a medium, e.g., a DVD (Digital Versatile Disk) or a CD (Compact Disk) that is detachable from the recording medium decoder 706 and portable may be used as the recording medium in place of or in addition to the HD. The recording medium 705 is not limited to a DVD or a CD, and a medium, e.g., a CD-ROM (CD-R, CD-RW), an MO, or a memory card that is detachable from the recording medium decoder 706 and portable may be utilized.

The map information stored in the recording medium 705 has background data representing features, e.g., buildings or a ground level in the theme park and road shape data representing shapes of roads (paths), and is two-dimensionally or three-dimensionally drawn in a display screen of the display unit 703. When the communication terminal 404 is providing path guidance, the map information recorded in the recording medium 705 and a current position of the communication terminal 404 itself acquired by the position acquiring unit 704 are displayed in the display screen of the display unit 703 in an superimposed manner.

The map information is recorded in the recording medium 705 in Example 1; however, the present invention is not limited thereto. A recording target of the map information is not limited to a member integrally provided with hardware of the communication terminal 404 alone, and may be provided outside the communication terminal 404. In this case, for example, the communication terminal 404 acquires the map information from a predetermined network through the communicating unit 708 and stores the acquired map information in, for example, a RAM. In the recording medium 705 may be also record the user ID. The user ID may be recorded in the ROM or the RAM in the terminal controller 701.

The recording medium decoder 706 controls reading/writing information from/onto the recording medium 705. For example, when an HD is used as the recording medium 705, the recording medium decoder 706 is an HDD (Hard Disk Drive). Likewise, when a DVD or a CD (including a CD-R or a CD-RW) is used as the recording medium 705, the recording medium decoder 706 is a DVD drive or a CD drive. When a CD-ROM (CD-R, CD-RW), an MO, or a memory card is used as the writable and detachable recording medium 705, a dedicated drive device that can write information into various kinds of recording mediums and read information stored in the various kinds of recording mediums is appropriately used as the recording medium decoder 706.

The audio output unit 707 controls an output to the connected speaker 712 to play guidance sounds. The number of speakers 712 may be one or more. Specifically, the audio output unit 707 can be realized by an audio I/F connected with the audio output speaker 712. More specifically, the audio I/F can be formed of, for example, a D/A converter that performs D/A conversion of audio digital information, an amplifier that amplifies an audio analog signal output from the D/A converter, and an A/D converter that performs A/D conversion of audio analog information.

The communicating unit 708 performs communication with communication devices, e.g., the park entrance gate device 307, the park exit gate device 308, the communicator 304, the exit gate device 405, the general gate device 502, and the reservation holder gate device 503 to receive information from the management apparatus 501 or supply identification information of the communication terminal 404 itself to the management apparatus 501.

The path searching unit 709 utilizes, for example, the map information stored in the recording medium 705 to search for an optimal path from a departure point to a destination point. Here, the optimal path means, for example, a minimum (or the quickest) path to the destination point or a path that is most likely to meet conditions specified by a user. For example, when moving from a crowded attraction to an uncrowded attraction, a position of the crowded attraction is determined as a departure point, and a position of the uncrowded attraction is determined as a destination point.

The management apparatus 501 may search for a destination point. That is, the management apparatus 501 may acquire current position information of the communication terminal 404 to search for a path to a destination point and transmit path information of the found path to the communication terminal 404. In particular, this is effective when the management apparatus 501 determines a destination point of the communication terminal 404. In this case, the later-explained path guiding unit 710 performs path guidance based on the path information transmitted from the management apparatus 501.

The path guiding unit 710 generates real-time path guidance information based on the information of the guidance path found by the path searching unit 709, the position information of the communication terminal 404 acquired by the position acquiring unit 704, and the map information obtained from the recording medium 705 through the recording medium decoder 706. The information concerning the guidance path generated by the path guiding unit 710 is output to the display unit 703 or the audio output unit 707 via the terminal controller 701.

When the management apparatus 501 searches for a path of the communication terminal 404, the path guiding unit 710 acquires information of path guidance from the management apparatus 501 via the communicating unit 708. The acquired information concerning the path guidance is output to the display unit 703 or the audio output unit 707 via the terminal control unit 701.

The audio generator 711 generates information of a tone and sound associated with a pattern. That is, it sets a virtual sound source associated with a guidance point and generates audio guidance information based on the information of the path guidance produced by the path guiding unit 710, and outputs the generated information to the audio output unit 707 through the terminal controller 701.

### Data Managed by Theme Park Management Apparatus

Data managed by the management apparatus 501 will now be explained. The management apparatus 501 uses the following data to manage the theme park. An attraction list according to Example 1 will be first explained. FIG. 8 is an explanatory drawing of an attraction list. An attraction list 800 includes a “name” area 801, a “genre” area 802, a “congestion (past)” area 803, and a “user layer” area 804.

The name area 801 stores the name of each attraction 401, and the genre area 802 stores the genre of the attraction 401. Example 1 will be explained hereinafter on the assumption that the respective attractions A to E depicted in FIG. 3 are A=ferris wheel, B=roller coaster, C=haunted house, D=merry-go-round, and E=labyrinth.

The congestion (past) area 803 stores information concerning congestion in the past. Past congestion can be obtained based on, for example, an average wait-time in the past for each attraction. More specifically, past congestion is determined to be high or low based on whether the average wait-time in the past is longer or shorter than a predetermined wait-time. For example, when a predetermined wait-time for a given attraction 401 is set to 60 minutes, the congestion is determined to be low if the calculated average wait-time in the past is 30 minutes, and it is determined to be high when the calculated average wait-time in the past is 70 minutes. This predetermined wait-time is set for each attraction 401 by the theme park according to the drawing power (popularity) of each attraction 401, for example.

The average wait-time in the past for each attraction 401 may be calculated daily, may be calculated for the same day in the same month, or may be calculated for the same date. Here, the average wait-time in the past calculated for the same day is specifically an average value of wait-times in a predetermined period in the past or a fixed period, e.g., “Sunday” since opening of the theme park. The average wait-time calculated for the same day in the same month is specifically an average value of wait-times on “Saturday of the first week in May” in the past. The average wait-time calculated for the same date is specifically an average value of wait-times on, for example, “May 5”, in the past.

The average wait-time in the past for each attraction 401 may be calculated for a time slot as a unit in lieu of or in addition to one day as a unit. In this case, past congestion for the attraction list 800 is set for each time slot or for each time slot on a specific date. Setting the past congestion for each time slot in this manner enables obtaining a highly accurate expected wait-time when calculating the later-explained expected wait-time.

The user layer area 804 stores information concerning a user layer for each attraction 401 obtained based on the user ID. Information concerning, for example, a latitude/longitude of a point where the attraction 401 is located may be stored in the attraction list 800.

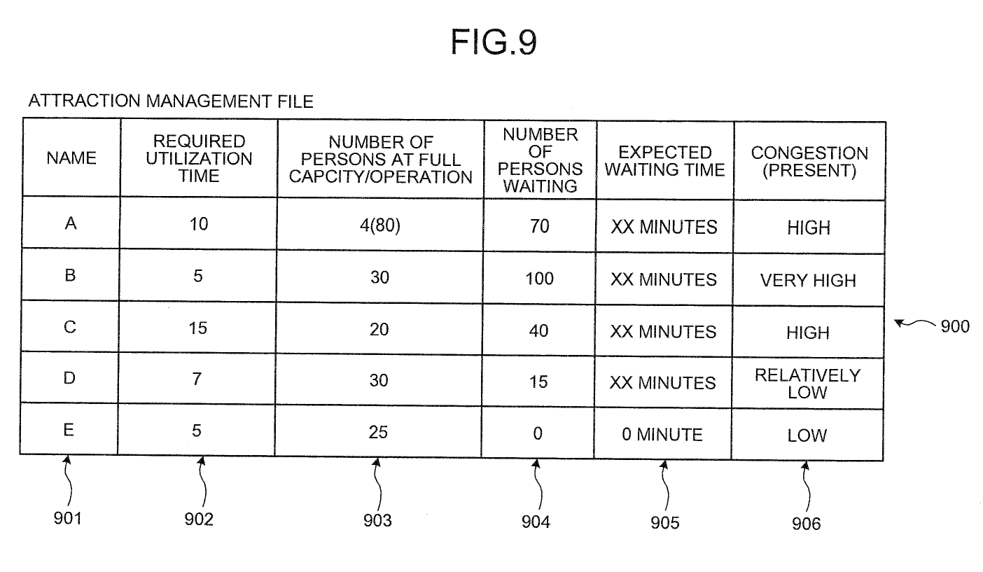

An attraction management file will now be explained. FIG. 9 is a schematic of an attraction management file. An attraction management file 900 includes a name area 901, a utilization required time area 902, a “number-of-available-persons/operation” area 903, “a number of persons waiting” area 904, an “expected wait-time” area 905, and a “congestion (present)” area 906. The name area 901 stores the same information as that in the name area 801 in the attraction list 800 depicted in FIG. 8.

The utilization required time area 902 stores the time required to utilize each attraction 401 (required utilization time). The number of persons at full capacity per operation area 903 stores the number of persons at full capacity with respect to a single operation of each attraction 401. The time required for utilization and the number of persons at full capacity per operation are specified values preset by the theme park.

The number of persons waiting area 904 stores the number of users currently waiting (hereinafter, “current number of persons waiting”) for each attraction 401. The current number of persons waiting can be obtained based on a communication result between each communicator 304 and the communication terminal 404 carried by each user. For example, when the same identification information is received in a predetermined range, e.g., within a given periphery of the attraction 401 for a fixed time or longer, a user (or a group including the user) identified by this identification information is counted in the current number of persons waiting for the attraction 401. A distance storage area, (not depicted) where a distance from the entrance gate 402 of each attraction 401 to the very end of a current waiting line is stored, may be provided in place of the number of persons waiting area 804.

The expected wait-time area 905 stores a wait-time expected at the time the expected wait-time is calculated (hereinafter, “expected wait-time”). The expected wait-time is a time expected to be required for a user, standing at the end of a waiting line for utilization of the attraction 401, to be able to use the attraction 401 at the time the expected wait-time is calculated. The expected wait-time can be calculated based on, for example, the time required for utilization, the number of persons at full capacity, and the current number of persons waiting.

The expected wait-time according to Example 1 is calculated with consideration of the number of users having made reservations of each attraction (hereinafter, “reservation holders”) as the number of persons waiting. The number of reservation holders can be acquired by additionally providing a table storing the number of reservation holders for each attraction 401 and making reference to this table when calculating the expected wait-time. When the distance storage area is provided in place of the number of persons waiting area 904, an expected wait-time 905 is calculated from the distance from the entrance gate 402 of each attraction 401 to the end of the current waiting line for utilization of this attraction.

The expected wait-time may be calculated by adding the average wait-time in the past for each attraction 401 that is used when setting the past congestion in the attraction list 800. Specifically, for example, when the average wait-time in the past at the time of calculating the expected wait-time tends to become long, an arithmetic operation of, for example, multiplying a value calculated based on the time required for utilization, the number of persons at full capacity, and the current number of persons waiting including the number of reservation holders by a coefficient larger than 1.0 is executed.

The phrase “at the time of calculating the expected wait-time” means that an average wait-time on “Saturday of the first week in May” is used as relevant information when the time point of calculating the expected wait-time is “Saturday of the first week in May”, for example. The expected wait-time may be calculated daily or may be calculated for each time slot on a specific date.

An average value of a “wait-time per unit number of visitors” obtained by dividing a wait-time record for each day, used when calculating the average wait-time in the past, by the total number of visitors may be calculated, and this average value of the “wait-time per unit number of visitors” may be multiplied by a cumulative total of number of visitors until a given time in the day when the expected wait-time is calculated so that the expected wait-time can be calculated as an expected wait-time at that given time on that particular day. In this case, the expected wait-time may be calculated for each day or may be calculated for each time slot as in the above example. When the expected wait-time is calculated for each time slot, a more accurate expected wait-time can be calculated.

The congestion (present) area 906 stores information concerning current congestion. Current congestion is determined based on the expected wait-time. More specifically, current congestion is determined to be high or low depending on whether a calculated expected wait-time is longer or shorter than a predetermined wait-time, for example. For instance, when the predetermined wait-time is set to, for example, 30 minutes, the congestion is determined to be low if the calculated wait-time is 20 minutes, and it is determined to be high when the calculated wait-time is 45 minutes.

Current congestion may be determined to be, for example, “relatively high”, “very high”, “relatively low”, or “low” in levels based on how many minutes the calculated wait-time is longer or shorter than the predetermined wait-time. In this case, the current congestion may be determined in stages by calculating a percentage of the calculated wait-time with respect to the predetermined wait-time to obtain the percentage that the calculated wait-time has increased (or decreased) with respect to the predetermined wait-time rather than based on how many minutes the calculated wait-time is longer (or shorter) than the predetermined wait-time.

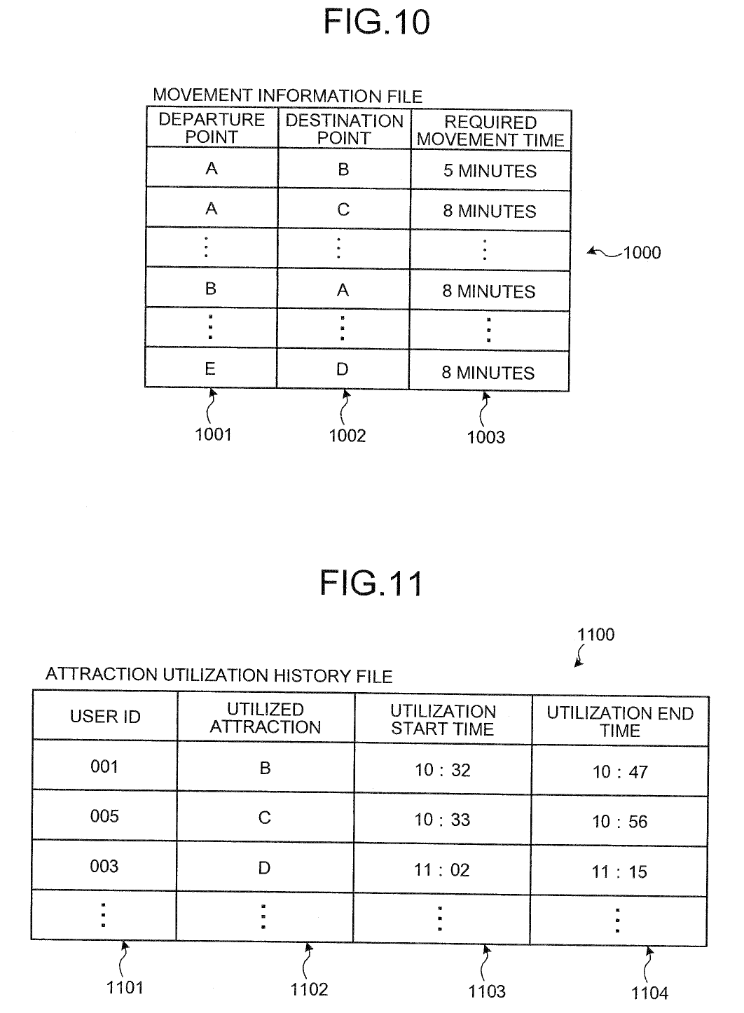

A movement information file will now be explained. FIG. 10 is a schematic of a movement information file. A movement information file 1000 includes a “departure point” area 1001, a “destination point” area 1002, and a “required movement time” area 1003. (Names) of the attractions 401 that become a departure point and a destination point when, for example, moving from a crowded attraction 401 to an uncrowded attraction 401 are stored in the departure point area 1001 and the destination point area 1002. The required movement time area 1003 stores the time required to move between the two attractions 401, i.e., the departure point and the destination point. The required movement time is the time required for one-way movement from one attraction 401 to the other attraction 401.

An attraction utilization history file will now be explained. FIG. 11 is a schematic of an attraction utilization history file. An attraction utilization history file 1100 includes a “user ID” area 1101, a “utilized attraction” area 1102, a “utilization start time” area 1103, and a “utilization end time” area 1104.

The user ID area 1101 stores a user ID used as identification information for identifying the communication terminal 404. The utilized attraction area 1102 stores (a name of) the attraction 401 utilized by a user. The utilization start time area 1103 stores the time that a user starts using the attraction. Specifically, the time that a user having the user ID shown in the user ID area 1101 passes through the general entrance gate 402 or the reservation holder entrance gate 403 (see FIG. 4) provided at the attraction 401, shown in the utilized attraction area 1102, is stored.

The utilization end time area 1104 stores the time that a user finishes utilization of the attraction. Specifically, the time that a user having the user ID shown in the user ID area 1101 passes through the exit gate 406 (see FIG. 4) provided at the attraction 401, shown in the utilized attraction area 1102, is stored.

A guidance/privilege information file according to Example 1 will now be explained. Some of the attractions 401 in the theme park are popular/unpopular, and the number of users waiting for each of the attractions is not uniform. When users are concentrated at some of the attractions 401, wait-times are increased, and satisfaction levels of the users are reduced. Capacity operating rates of the other attractions 401 are lowered, resulting in inefficiency.

Therefore, when users are biased toward some of the attractions 401 in the theme park, the management apparatus 501 transmits information urging movement in the theme park (hereinafter, “transmission information”) to the communication terminal 404 of each user. The transmission information includes guidance information urging movement to a predetermined position in the theme park as well as incentive (privilege) information that becomes valid when the user follows the guidance. Such an incentive triggers dispersion of the users to the respective attractions 401.

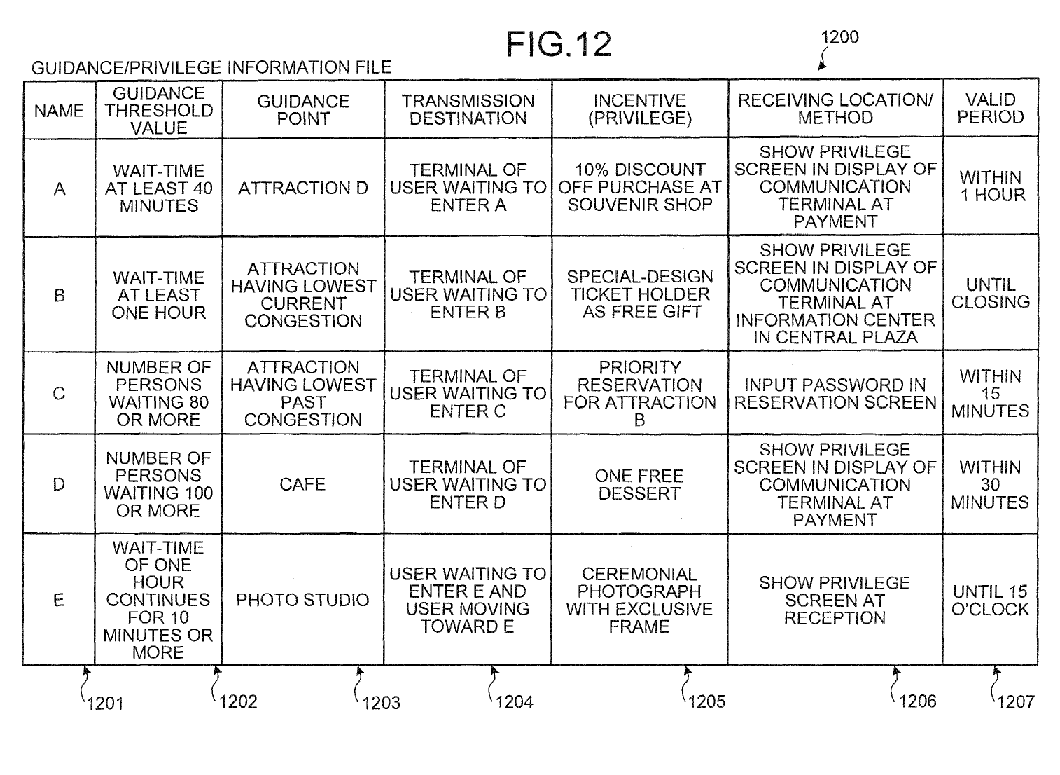

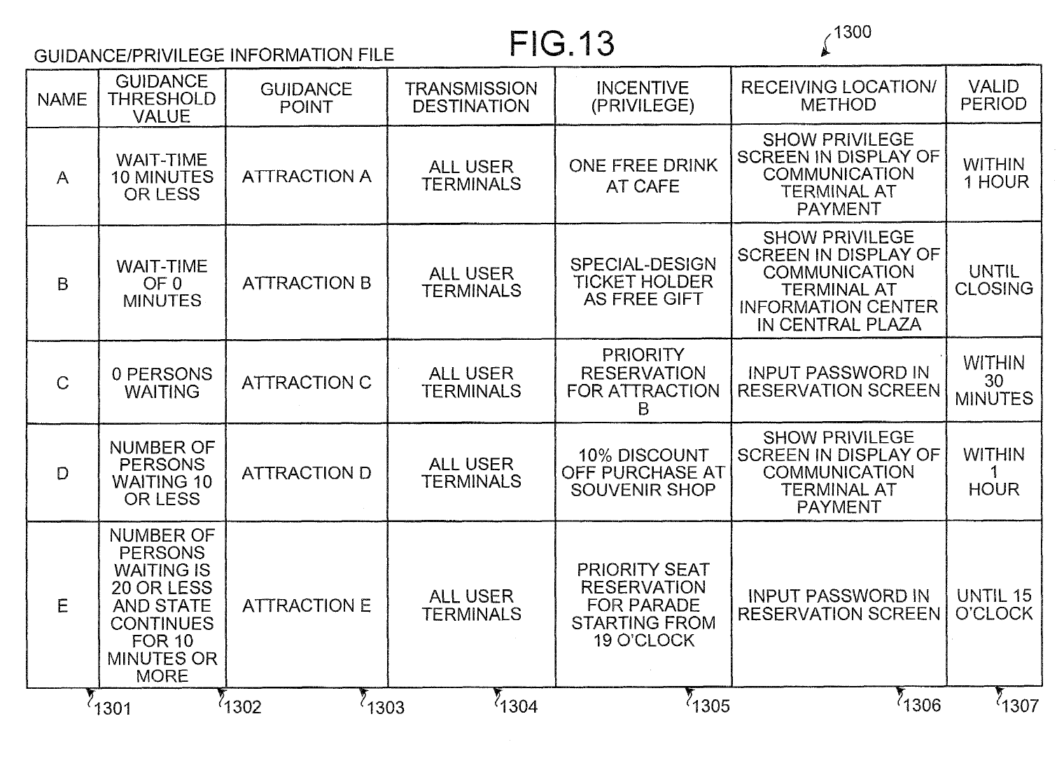

FIGS. 12 and 13 are schematics of the guidance/privilege information file. A guidance/privilege information file 1200, 1300 includes a “name” area 1201, 1301; a “guidance threshold value” area 1202, 1302; a “guidance point” area 1203, 1303; a “transmission destination area” 1204, 1304; an “incentive (privilege)” area 1205, 1305; a “receiving position/method” area 1206, 1306; and a “valid period” area 1207, 1307.

The name area 1201, 1301 stores the same information as the name area 801 in the attraction list 800 depicted in FIG. 8. The guidance threshold value area 1202, 1302 stores a guidance threshold value for each attraction 401. The guidance threshold value differs depending on each attraction, and is represented in the form of the number of persons waiting or a wait-time. When the number of persons waiting or a wait-time of each attraction exceeds a value indicated in the guidance threshold value area 1202, 1302, the management apparatus 501 transmits the transmission information to the communicator 304 carried by each user.

The guidance threshold value depicted in FIG. 12 corresponds to an example where the number of persons waiting or a wait-time becomes equal to or above a predetermined number, and indicates that the attraction is crowded. The guidance threshold value in FIG. 13 corresponds to an example where the number of persons waiting or a wait-time becomes equal to or below the predetermined number or an example where the same becomes zero, and indicates that the attraction is uncrowded. When a state in which the number of persons waiting or a wait-time is not smaller than or not greater than the predetermined number continues for a predetermined time such as with the attraction E, this may be determined as the guidance threshold value.

The guidance point area 1203, 1303 stores a guidance point that each user is guided to by the transmission information. As shown in FIG. 12, when each attraction 401 is crowded, another attraction 401 or a commercial facility (e.g., a cafe or a souvenir shop) in the theme park is determined as the guidance point. As shown in FIG. 13, when the attraction 401 is not crowded, the attraction 401 is determined as the guidance point. For example, when the attraction A is not crowded, the attraction A is determined as the guidance point.

As shown in FIG. 12, when another attraction 401 or a commercial facility in the theme park is determined as the guidance point, the guidance point may be set to a certain guidance point or may differ depending on congestion in each situation. For example, as shown in FIG. 12, the guidance point of the attraction A is set to the attraction D. On the other hand, the guidance destination of the attraction B is the attraction with the lowest congestion at the present moment. The guidance point is determined based on the current congestion indicated in the congestion (present) area 906 depicted in FIG. 9.

At this time, considering a genre of the attraction 401 indicated in the genre area 802 depicted in FIG. 8, an attraction having a similar characteristic may be determined as a destination point. For example, the attraction A (Ferris wheel) belongs to a genre “amusement ride/scenery type”. Therefore, the attraction D (merry-go-round), the same type of amusement ride, which is calm and enables enjoying the scenery, is determined as the destination point, for example. Additionally, the guidance point may be determined based on a user layer of the attraction 401 indicated in the user layer area 804 depicted in FIG. 8.

As with the attraction C, the guidance point may be determined based on past congestion indicated in the congestion (past) area 803 in FIG. 8. In this case, for example, reference is made to past congestion having conditions coinciding with the current conditions (e.g., a day or a date), and the attraction with the lowest congestion is determined as the guidance point. As explained above, when determining the guidance point while considering the present or past congestion, or the genre of the attraction 401, one of these elements may be considered, or a combination of the elements may be considered.

The transmission destination area 1204, 1304 stores a transmission destination of the transmission information. Specifically, the communication terminal of a user in a given state that the transmission information is supplied to is stored. The transmission information may be transmitted to the communication terminal of a user who is waiting to enter a given attraction 401 or moving toward a given attraction as depicted in FIG. 12, or the transmission information may be transmitted to the communication terminals of all the users in the theme park as depicted in FIG. 13.

Here, a judgment upon whether the user is one who is waiting to enter the given attraction 401 is made by using, for example, an intensity of reception radio waves received from the communication terminal 404 or information of a current position of the communication terminal 404 to judge whether the user is located in a predetermined range from the attraction 401. To discriminate a user passing near the attraction from a user waiting to enter the attraction, a user who keeps receiving the above-explained information for a given period of time or longer may be determined as the user waiting to enter the attraction.

Whether the user is a user moving toward a specific attraction is judged by tracing a change in a current position of the user. For example, when the paths 302a to 302e leading to the respective attractions A to E extending from the plaza 301 as shown in FIG. 3, a user having current positions in the respective paths 302a to 302e and moving toward the respective attractions A to E (directions opposite to the plaza 301) is determined to be moving toward the respective attractions A to E.

The incentive area 1205, 1305 stores the contents of a privilege given to a user who follows the guidance of the transmission information. The privilege given to the user following the guidance of the transmission information includes the offering of preferential treatment or a gift at a nearby restaurant or souvenir shop and may be a privilege that does not provoke a cost like a priority reservation of a popular attraction.

The receiving location/method area 1206, 1306 stores a receiving position or a receiving method of a privilege. When the privilege receiving location is different from the guidance location (e.g., a discount is received at a souvenir shop when using the attraction 401 that the user is guided to), the user is guided to both the privilege receiving location and the guidance location.

A valid period of a privilege is recorded in the valid period area 1207, 1307. The valid period of a privilege is, for example, a time limit for a user to reach a guidance point after transmission of the transmission information. When a user does not move within this time limit, the management apparatus 501 cannot grant a privilege to the user.

Although not depicted in particular, the theme park management apparatus also includes a user management file storing the user IDs and the number of persons in a group that users having the user IDs and carrying the communication terminals 404 belong to in association with each other. In this user management file, a profile of the group (e.g., gender, age, relationship (family, friends), etc.) may be stored correlated with each other. The user management file is required when a group of persons carries one communication terminal, and it is not necessarily required when each user carries the communication terminal 404.

### Method of Acquiring Current Position of Communication Terminal 404

A method of calculating a current position of a user will now be explained. In Example 1, a current position of a user can be acquired by using the GPS or the communicator 304. When using the GPS, GPS information received by the position acquiring unit 704 (see FIG. 7) is utilized to obtain the latitude/longitude of the communication terminal 404. Latitude/longitude information obtained from the communication terminal 404 is transmitted to the management apparatus 501.

When using the communicator 304, alternative GPS information transmitted from the communicator 304 is utilized to obtain current position information of the communication terminal 404. In this case, the current position information may be calculated by the management apparatus 501 or by the communication terminal 404. In any case, mutually transmitting the calculated information enables identifying a position of the communication terminal 404.

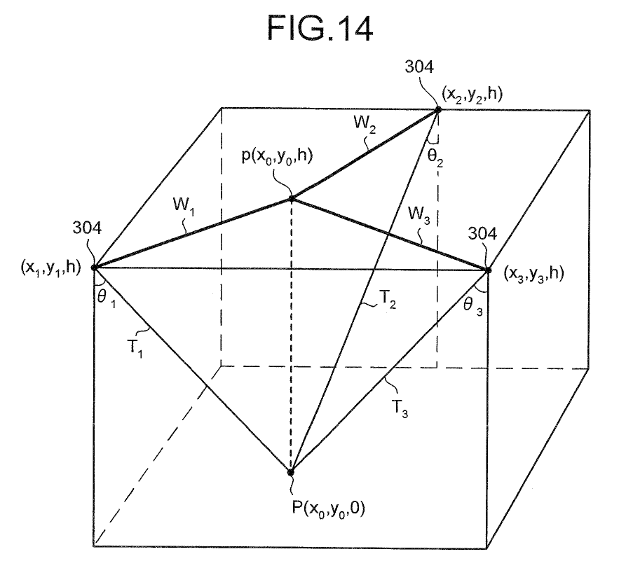

FIG. 14 is a schematic of an example of a method of calculating a current position from the alternative GPS information. The position acquiring unit 704 uses the Alternative GPS information transmitted from the communicators 304 to calculate a current position of a user based on a trigonometrical survey method. The alternative GPS information is a signal that can substitute for a signal transmitted from the GPS satellite when calculating a current position of the user, and is coordinate information three-dimensionally representing an installed position of each communicator 304 in Example 1.

As shown in FIG. 14, a position P of a user denoted by reference character P is indicated as a coordinate (x₀, y₀, 0). Positions of the three communicators 304 are indicated as coordinates (x₁, y₁, h), (x₂, y₂, h), and (x₃, y₃, h), respectively. Here, h is a height from the ground of the theme park to an installed position of the communicator 304, and is the same at positions where the respective communicators 304 are installed. It is assumed that x₁ to x₃ are known from position information included in the alternative GPS information. As a result, distances W₁ to W₃ between the respective communicators 304 can be obtained.

Distances T₁ to T₃ from the respective communicators 304 to the user can be obtained based on periods from transmission of the alternative GPS information by the respective communicators 304 to reception of the same by the position acquiring unit 704. The distances T₁ to T₃ themselves do not have to be obtained, and acquiring a ratio of the distances T₁ to T₃ can suffice. Here, reference character p in FIG. 14 denotes a position when the position P of the user is projected onto a virtual plane having the same height as the installed height of each communicator 304 and it is indicated as a coordinate (x₀, y₀, h).

When angles formed between virtual lines each connecting each communicator 304 with the current position of the user and plumb lines each running through each communicator 304 are θ1, θ2, and θ3, the height h from the ground of the theme park to the installed position of each communicator 304 is h=T1×cos θ₁=T₂×cos θ₂=T₃×cos θ₃. Based on this relationship, a trigonometric function can be used to obtain a position of x₀, y₀, thereby calculating the current position of the user.

The identification information output from the communication terminal 404 includes timing information that specifies an output timing of this identification information, and identification information including the same timing information is used to calculate the current position of the user. Consequently, even if (the user utilizing) the communication terminal 404 moves after time passes, the current position of the user can be accurately calculated at each timing.

Although not depicted, when movement of the user is fixed to a straight line (one dimension) where the two communicators 304 are placed, e.g., when the paths in the theme park are provided in the form of a matrix and each communicator is provided at each intersection of the paths, receiving the alternative GPS information from the two communicators 304 enables calculating the current position of the user. In such a case, using a coordinate in the theme park rather than using the same latitude/longitude as that of the GPS in particular enables performing more appropriate map matching.

Position information of the user may be obtained from position information of each attraction 401 in the theme park and a waiting order of the user. Usually, a waiting line for the attraction 401 in the theme park is formed at a fixed position around this attraction 401. Therefore, a position of the user can be also specified from position information, e.g., a latitude/longitude of the attraction 401 and an order of the user in the waiting line.

### Theme Park Management Processing by Management Apparatus 501

The detail of theme park management processing by the management apparatus 501 will now be explained. As explained above, some of the attractions 401 in the theme park are popular or unpopular, and the number of users waiting for each of the attractions is not uniform. When users are concentrated at some of the attractions 401, wait-times are increased, and satisfaction levels of the users are decreased. Capacity operating rates of the other attractions 401 are lowered, resulting in inefficiency.

Therefore, when users are biased toward particular attractions 401 in the theme park, the management apparatus 501 transmits information urging movement in the theme park (hereinafter, “transmission information”) to the communication terminals 404 of the users. The transmission information includes guidance information urging movement to a predetermined position (guidance location) in the theme park as well as information (privilege information) concerning an incentive (privilege) that becomes valid when a user follows the guidance to move. Granting such a privilege enables increasing the users who follow the guidance information, thereby more efficiently adjusting the distribution of the users.

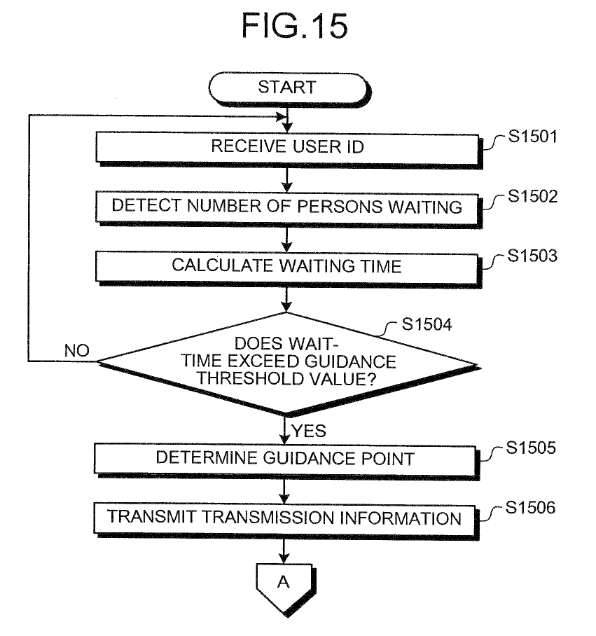

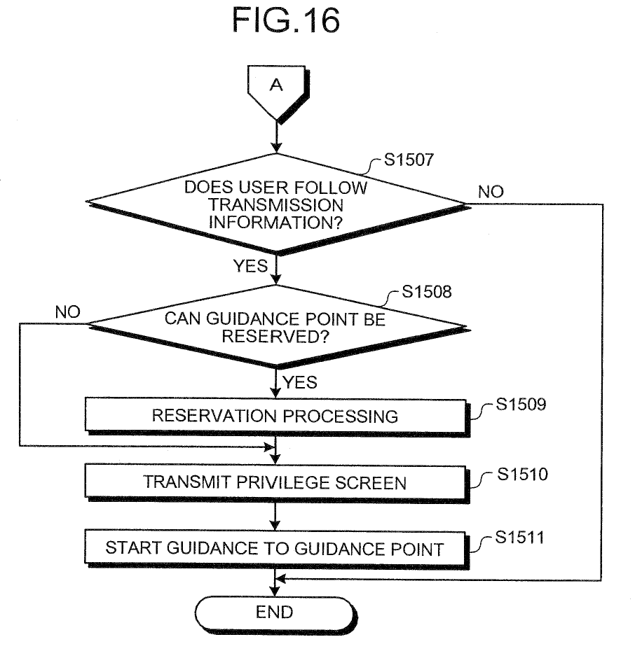

FIGS. 15 and 16 are flowcharts of a procedure of the theme park management processing by the management apparatus. FIG. 15 depicts processing for one attraction, and it is assumed that the management apparatus 501 executes the same processing for each of the attractions 401 in parallel. First, a user ID of a user waiting to enter the attraction is received from the communicator 304 provided at the passage gate 303 of the attraction 401 (step S1501).

A judgment whether the user is waiting to enter the attraction 401 is made by judging whether the user is located within a predetermined range from the attraction 401 based on, for example, an intensity of reception radio waves received from the communication terminal 404 by the communicator 304 or current position information of the communication terminal 404. To discriminate a user passing near the attraction from a user waiting to enter the attraction, a user who keeps receiving the above-explained information for a given period time or longer may be determined as a user waiting to enter the attraction.

Then, the number of persons waiting to enter the attraction 401 is detected from the number of the acquired user IDs (step S1502). A wait-time is also detected from the detected number of persons waiting (step S1503). The wait-time can be calculated by dividing the number of persons waiting to enter the attraction by the number of persons at full capacity per operation and multiplying the result by the time required to use the attraction. The wait-time does not have to be calculated when a later-explained guidance threshold value is used as the number of persons waiting.

Then, the management apparatus 501 judges whether the number of persons waiting or the wait-time exceeds the guidance threshold value (step S1504). Specifically, the management apparatus 501 judges whether the number of persons waiting or the wait-time exceeds a value indicated in the guidance threshold value area 1202, 1302 depicted in FIG. 12 or 13. For example, in case of the attraction A, the management apparatus 501 judges whether the wait-time is 40 minutes or longer (crowded) or the wait-time is 10 minutes or less (uncrowded).

When the number of persons waiting or the wait-time exceeds the guidance threshold value (step S1504: YES), a guidance point that each user is guided to is determined (step S1505). As the guidance point, a point indicated in the guidance point area 1203, 1303 shown in FIGS. 12 and 13, respectively, is determined. For example, in case of the attraction A, the attraction D is determined as the guidance point in a crowded state (FIG. 12), and the attraction A is determined as the guidance point in an uncrowded state (FIG. 13). On the other hand, when the number of persons waiting or the wait-time does not exceed the guidance threshold value (step S1504: NO), the control returns to the step S1501 to repeat the subsequent processing.

When the guidance point is determined at step S1505, the management apparatus 501 transmits the transmission information to a transmission destination indicated in the transmission destination area 1204, 1304 shown in FIG. 12 and FIG. 13, respectively (step S1506). For example, in case of the attraction A, the transmission information is transmitted to users waiting to enter the attraction A in the crowded state (FIG. 12), and is transmitted to all users in the uncrowded state (FIG. 13).

The transmission information may be transmitted with consideration of the wait-time of each user or the number of persons already waiting to enter the attraction. For example, because a user standing at the end of a waiting line has a long wait-time, the user has a high probability of following the guidance, and hence, transmission of the transmission information is effective. On the other hand, because a user standing at the front of the waiting line can utilize the attraction soon (the wait-time is short), the user may not follow the guidance even if the transmission information is transmitted, resulting in a meaningless transmission. Further, if the user standing at the front of the waiting line can use the attraction within a valid period of later-explained privilege information, the user utilizes the crowded attraction and also earns the privilege. Therefore, transmission of the transmission information may be limited to the communication terminal of a user whose wait-time is equal to or greater than a given value, or the communication terminal of a user whose order in the waiting line is equal to or greater than a given value.

Here, the transmission information includes the guidance information urging movement to the guidance point determined at step S1505 as well as privilege information that becomes valid when a user follows the guidance information. Specifically, the privilege information is contents of a privilege indicated in the incentive area 1205, 1305 in FIGS. 12 and 13, respectively. For example, in case of the attraction A, a 10% discount off a purchase at a souvenir shop is a privilege in the crowded state (FIG. 12), and providing a free drink at a cafe (restaurant) is a privilege in the uncrowded state (FIG. 13).

The transmission information also includes, for example, interface (screen display and others) information for confirming whether a user of the communication terminal having the transmission information transmitted thereto follows the transmission information. The user transmits, to the management apparatus 501 through an interface realized by the interface information, a decision as to whether the user will follow the transmission information.

FIG. 16 is explained. The management apparatus 501 judges whether the user of the communication terminal 404 that is the transmission destination follows the transmission information (step S1507). Specifically, the management apparatus 501 makes a judgment at step S1507 based on the decision as to whether the user will follow the transmission information, the decision being transmitted by the user through the interface included in the transmission information.

When the user follows the transmission information (step S1507: YES), whether the guidance point can be reserved is judged (step S1508). When the guidance point can be reserved (step S1508: YES), processing of reserving the guidance point is executed (step S1509). When the guidance point can be reserved, this means that the guidance point is an attraction or a restaurant where the user's place can be reserved. As a result, the user can enter the attraction or the restaurant at the guidance point without waiting.

On the other hand, when the guidance point cannot be reserved (step S1508: NO), the control advances to step S1510. When the user does not follow the transmission information at step S1507 (step S1507: NO), the processing based on this flowchart is terminated. Here, when the user does not follow the transmission information, this includes a situation where the user clearly expresses the intent to not follow the transmission information through the interface or does not express intent at all.

Then, the management apparatus 501 transmits a privilege screen showing that a privilege becomes valid to the communication terminal 404 (step S1510). However, even if the privilege screen is transmitted, the privilege cannot be immediately granted, but it can be granted only when the user moves to the guidance point. When the reservation processing is executed at step S1509, a reservation completion confirming screen may be transmitted together with the privilege screen.

The privilege screen includes information of a valid period of the privilege. The valid period of the privilege is a period for the user to reach the guidance point after transmission of the transmission information, and is specifically a period indicated in the valid period area 1207, 1307 shown in FIGS. 12 and 13, respectively. For example, in the case of the attraction A, the privilege cannot be granted unless the user reaches the guidance point within an hour after transmission of the transmission information in both the crowded state (FIG. 12) and the uncrowded state (FIG. 13).

Subsequently, guiding the user to the guidance point is started (step S1511), and the processing based on this flowchart is terminated. As the path guidance to the guidance point, specifically, the management apparatus 501 searches for a path to the guidance point and transmits route guidance assistance information for route guidance assistance to the guidance point to the communication terminal 404. The communication terminal 404 outputs the transmitted route guidance assistance information to the display unit 703 or the audio output unit 707 to guide the user to the guidance point.

When the guidance point is different from a point where the privilege can be granted, the management apparatus 501 provides the route guidance assistance information to both the points. When an order of movement is determined, the guidance is performed compliant to the order. For example, in case of the attraction A of FIG. 12, the guidance point is the attraction D, but a point where the privilege can be granted is a souvenir shop. Therefore, the management apparatus 501 first guides the user to the attraction D and then guides the user to the souvenir shop after utilization of the attraction D.

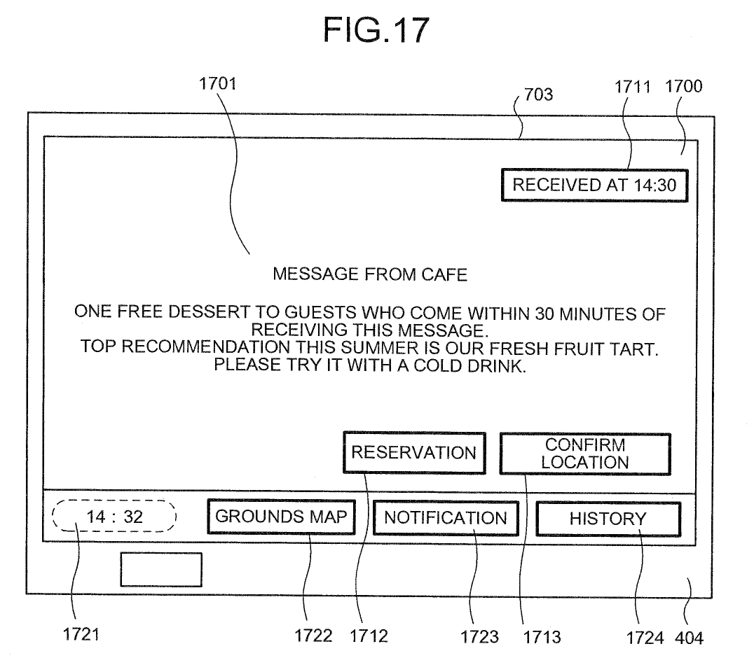

FIG. 17 is a view of an example of the display screen of the transmission information. The display unit 703 of the communication terminal 404 displays a display screen 1700 of the transmission information transmitted from the management apparatus 501. The display screen 1700 shows a message description 1701 indicates guidance information and privilege information. In the depicted example, the guidance point is a “cafe”, and the privilege granted when the user proceeds to the guidance point is “a free dessert”. The message description 1701 also includes a text reporting the attraction of the “cafe” as the guiding point.

The display screen 1700 also displays a received time indicator 1711. The user must reach the cafe within 30 minutes after receiving the transmission information. When proceeding to the cafe, the user can press a reservation button 1712 to make a reservation at the cafe. The user may determine whether he/she is going to proceed after confirming the location of the cafe on a map by pressing a location confirmation button 1713.

A current time indicator 1721, a grounds map button 1722, a notification button 1723, and a history button 1724 are displayed at a lower portion of the display unit 703. The current time indicator 1721 indicates the current time. The user can move toward the guidance point while making reference to the time indicated in the current time indicator 1721. When the grounds map button 1722 is pressed, an grounds map of the theme park is displayed. When the notification button 1723 is pressed, various kinds of information transmitted from, for example, the management apparatus 501 can be received/viewed.

When the history button 1724 is pressed, a utilization history indicative of attractions or commercial facilities that the user has used is displayed. The utilization history includes information of a utilization start time and a utilization end time. For example, when the guidance point is different from a point where a privilege is granted, the user may present the utilization history to a granter of the privilege (e.g., an attendant of the attraction 401 or an assistant at a cafe or a souvenir shop) to prove that the privilege is valid.

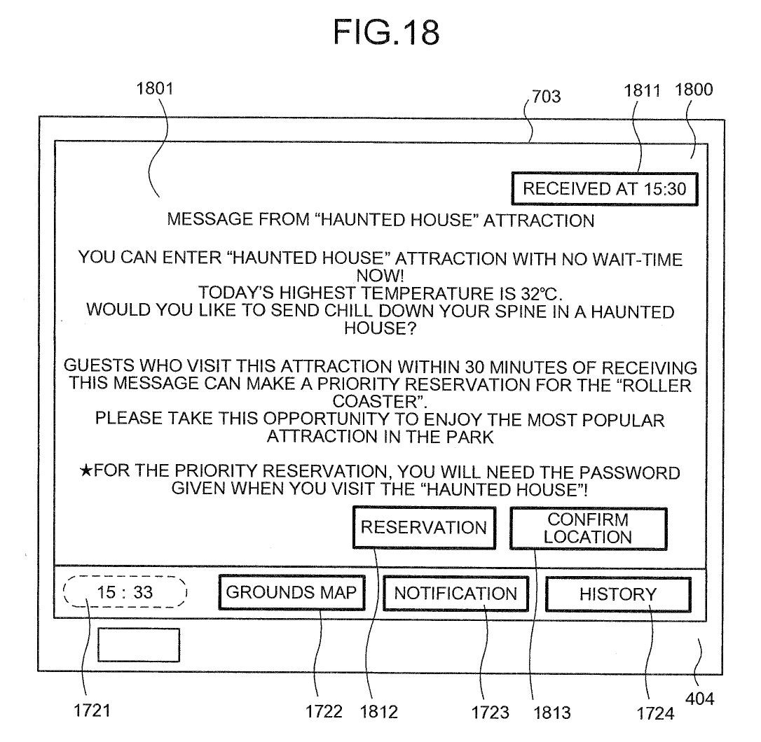

FIG. 18 is a view of another example of the display screen of the transmission information. The display unit 703 displays a display screen 1800 of the transmission information transmitted from the management apparatus 501. The display screen 1800 displays a message description 1801 indicating guidance information and privilege information. In the depicted example, the guidance point is the “haunted house (attraction C)”, and a privilege granted when the user proceeds to the guidance point is a “priority reservation for the roller coaster (attraction B)”. The message description 1801 includes text reporting the appeal of the “haunted house” as the guidance point.

The display screen 1800 also displays a received time indicator 1811. The user must reach the haunted house within 30 minutes after receiving the transmission information. When moving to the haunted house, the user can press a reservation button 1812 to make a reservation for the haunted house. The user can decide whether he/she is going to proceed to the haunted house after confirming the location of the haunted house on a map by pressing a location confirmation button 1813.

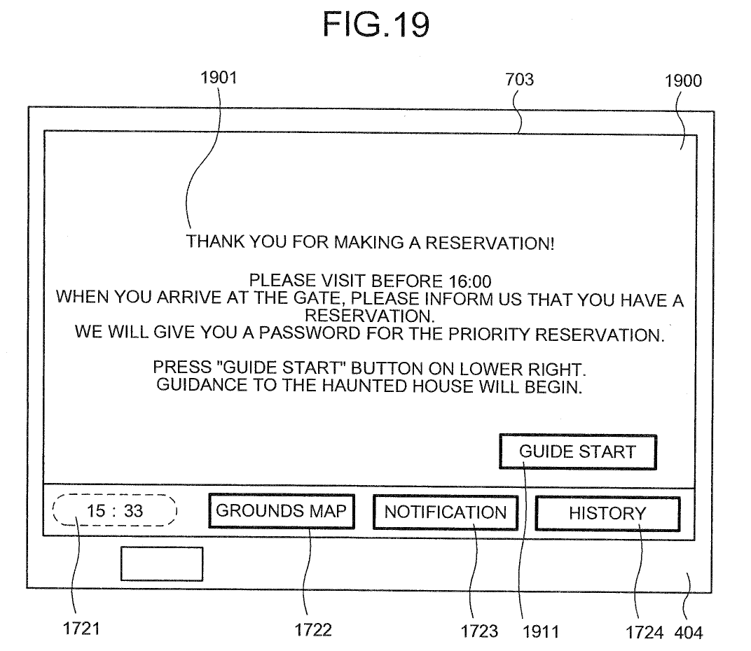

FIG. 19 is a view of an example of a display screen when the reservation button in FIG. 18 is pressed. The display unit 703 displays a reservation completion screen 1900, and a message description 1901 indicating that making a reservation at the haunted house has been completed is shown. The message description 1901 shows a valid period and/or a receiving method of the privilege. When a guide start button 1911 is pressed, route guidance assistance to the haunted house is started.

As explained above, according to the management apparatus 501 of Example 1, the guidance information and the privilege information are transmitted based on the number of persons waiting to enter the attraction 401 or the wait-time, thereby urging movement of the users in the theme park. As a result, the users can be prevented from being concentrated at particular attractions 401, thus promoting efficient operation of the theme park. When the privilege information is transmitted, user motivation for movement to the guidance point can be enhanced compared to an example where the guidance information is simply transmitted.

Determining the guidance point according to congestion in each situation enables uniform user distribution in the theme park, easing congestion, and improving capacity operating rates of the attraction(s) 401 having a low capacity operating rate.

Transmitting the transmission information to a user waiting to enter the attraction 401 with a high congestion level or moving toward this attraction 401 as a destination point enables dispersing the users from the attraction with the high congestion level. When a path from a current position of a user to the guidance point is searched for and a result of searching is transmitted to the communication terminal of the user, the user can be accurately moved to the guidance point.

### Second Embodiment

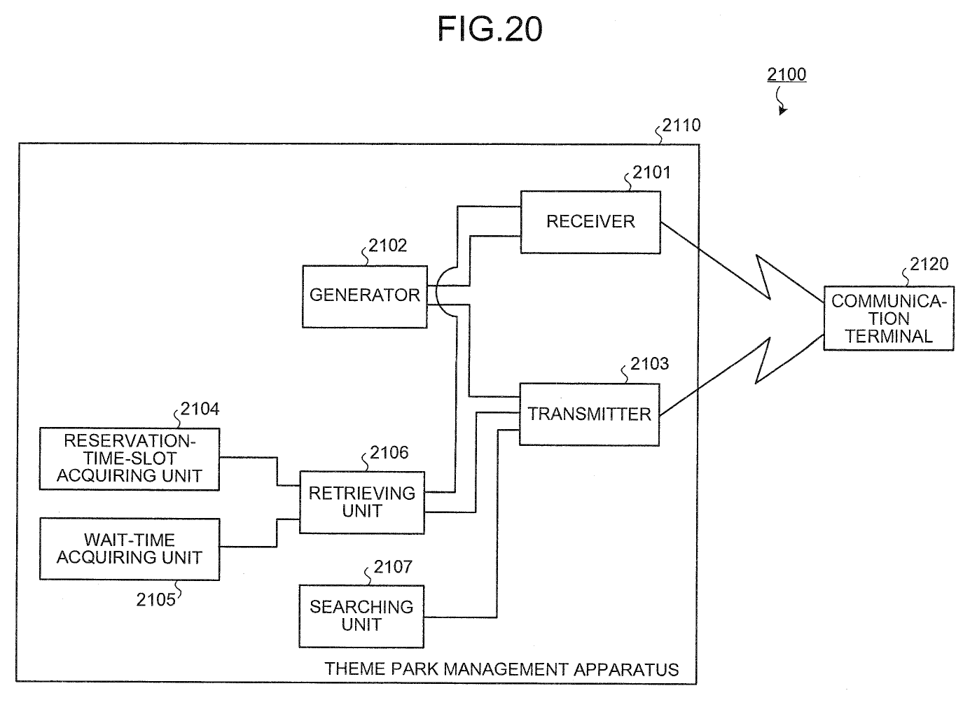

A functional structure of a theme park management system according to a second embodiment will now be explained. FIG. 20 is a block diagram of a functional structure of the theme park management system according to the second embodiment.

As shown in FIG. 20, a theme park management system 2100 includes a theme park management apparatus 2110 and a communication terminal 2120. The theme park management apparatus 2110 manages, for example, congestion in each attraction in a theme park. Here, the theme park means an amusement facility having plural attractions on the premises thereof.

The attraction is a facility at, for example, an amusement park, a zoo, a restaurant, a movie theater, or a facility having an ability to draw customers according to a theme. In an amusement park, attractions include a roller coaster, a Ferris wheel, and others. The attraction may be an attraction that is appreciated by users or an attraction involving action on the part of the users, e.g., riding an amusement ride. The user means a person visiting the theme park, or more particularly, a person who carries the communication terminal 2120. The user may be a single person or a group of plural users.

The communication terminal 2120 means a portable computer terminal that can be carried by the user. The communication terminal 2120 can perform communication with the theme park management apparatus 2110 directly or indirectly via a gate device of each attraction. The communication terminal 2120 may be lent by the theme park when, for example, the user enters the theme park, or may be a mobile phone owned by the user. One communication terminal 2120 may be utilized by each user or by each group.

The theme park management apparatus 2110 includes a receiver 2101, a generator 2102, a transmitter 2103, a reservation-time-slot acquiring unit 2104, a wait-time acquiring unit 2105, a retrieving unit 2106, and a searching unit 2107.

The receiver 2101 receives information concerning an attraction specified by a user (hereinafter, “specified attraction”) among the attractions provided in the theme park. The information concerning the specified attraction is specifically a name of the attraction or location information of the attraction. The receiver 2101 receives, for example, information concerning the specified attraction transmitted from the communication terminal 2120 of the user. The receiver 2101 may receive information concerning a time that the user exits the theme park as well as the information concerning the specified attraction. When plural attractions are specified, the receiver 2101 may receive a reservation priority order of the specified attractions specified by the user.

When the receiver 2101 receives the information concerning the specified attraction, the generator 2102 generates reservation information having a reservation time of the specified attraction assigned thereto. When generating the reservation information, whether a vacant frame in a table for reservations is present is confirmed for each attraction, and information specifying a user (e.g., a reservation number) with respect to the reservation table is written to assure the reservation of the user if a vacant frame is present. Then, information specifying the user writing the information for the reservation table and reservation information assigning a reservation table writing target (reservation time) are generated.

When the receiver 2101 receives a time that the user will exit the theme park, the generator 2102 may generate the reservation information based on information concerning the received time. Specifically, for example, the reservation is assured so that use of all the specified attractions is completed before the received time, and the reservation information is generated.

When the receiver 2101 receives a reservation priority order of the specified attractions, the generator 2102 may generate the reservation information based on the received reservation priority order. Specifically, for example, when time slots that reservations can be made with the specified attractions overlap, the specified attraction having a high reservation priority level is reserved first.

When a maximum number of attractions that can be simultaneously reserved is set, the generator 2102 may reserve the attractions in descending order of reservation priority level according to this maximum number. The number of the attractions that can be simultaneously reserved may be held in the theme park management apparatus 2110 or acquired from, for example, the communication terminal 2120.

If the maximum number of the attractions that can be reserved is set in this manner, the generator 2102 may add a reservation of an unreserved attraction having the higher reservation priority level when one reservation is processed and the number of the attractions that can be simultaneously reserved has leeway. In this case, the attraction used in a vacant time slot may be adjusted according to the added reservation to again generate the reservation information.

The transmitter 2103 transmits the reservation information generated by the generator 2102 to the communication terminal 2120 of the user. Additionally, a result of retrieval executed by the later-explained retrieving unit 2106 or a result of searching executed by the searching unit 2107 may be transmitted to the communication terminal 2120 of the user.

The reservation-time-slot acquiring unit 2104 acquires a reservation time slot for the specified attraction. Here, the reservation time slot is the time from the start of use of the reserved specified attraction to end thereof, and/or the time from entering an entrance gate to exiting an exit gate after using the attraction. For example, when the user must appear at a reservation holder gate at a predetermined time before a reserved time, the time that the users are supposed to appear is a utilization start time.

The reservation time slot may be a time slot when the user can start utilizing an attraction with priority over other users. For example, the reservation time slot may be a time slot that a user can use an attraction in preference to other users as long as the user passes through the entrance gate any time during the reservation time slot. In this case, the user utilizes a reserved specified attraction during a part of the reservation time slot and hence can utilize other attractions in other time slots during the reservation time slot. Therefore, during the reservation time slot the user may utilize the specified attraction and may consider other attractions that can be utilized during a part of the reservation time slot.

The wait-time acquiring unit 2105 acquires the wait-time of attractions than the specified attraction. The wait-time acquiring unit 2105 acquires the wait-time of other attractions upon receipt of a retrieval request signal by the receiver 2101. Specifically, for example, the number of persons waiting for other attractions at the instant of receiving the retrieval request signal by the receiver 2101 is divided by the number of persons at full capacity per operation, and the obtained result is multiplied by the time required for utilization, thereby calculating the wait-time. When past wait-time data or predicted wait-time data of each attraction is stored, this data may be acquired.

The retrieving unit 2106 retrieves an attraction that is can be utilized during a vacant time slot, i.e., a time slot other than the reservation time slot based on the reservation time slot acquired by the reservation-time-slot acquiring unit 2104 and the wait-time of other attractions than the specified attraction acquired by the wait-time acquiring unit 2105. Specifically, the retrieving unit 2106 retrieves an attraction satisfying a condition that all of the time required for moving to the attraction, wait-time, utilization time, and the time required to move to the next reserved attraction fall within the vacant time slot. When the retrieving unit 2106 successfully retrieves an available attraction, the transmitter 2103 transmits a retrieval result retrieved by the retrieving unit 2106 to the communication terminal 2120 of the user.

The searching unit 2107 searches for a path to a specified attraction. The searching unit 2107 uses a path search algorithm such as a Dijkstra method to search for a path to a specified attraction from the current position. When the searching unit 2107 successfully finds a path, the transmitter 2103 transmits information concerning the path found by the searching unit 2107 together with the retrieval result of the retrieving unit 2106 to the communication terminal 2120 of the user.

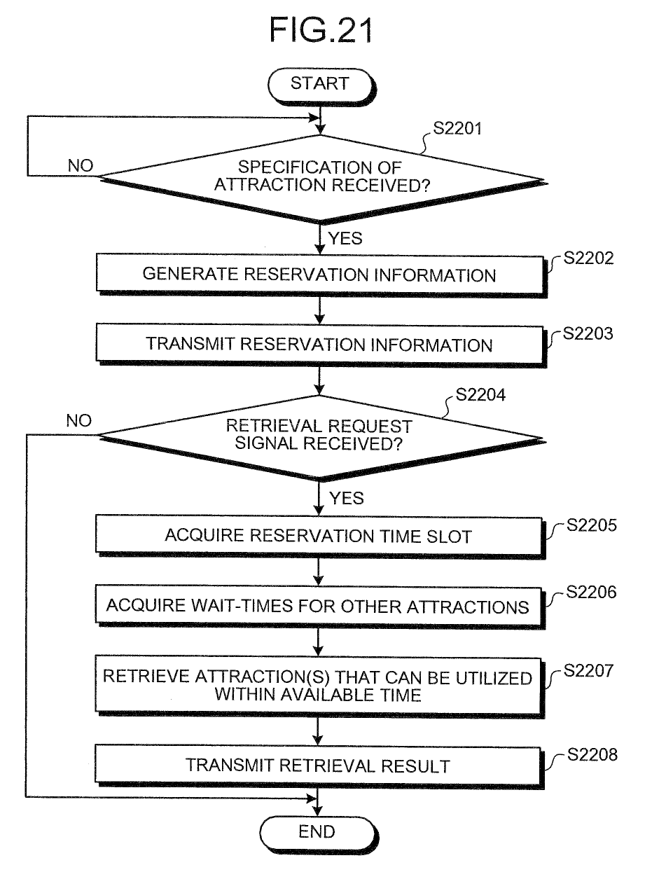

Processing by the theme park management apparatus 2110 will now be explained. FIG. 21 is a flowchart of a processing procedure executed by the theme park management apparatus. First, the theme park management apparatus 2110 waits until specification of an attraction from a user is received (step S2201: NO loop) Upon receipt of specification of an attraction (step 2201: YES), the generator 2102 generates reservation information (step S2202), and the generated reservation information is transmitted to the communication terminal 2120 of the user (step S2203).

Then, a judgment is made upon whether a retrieval request signal is received from the communication terminal 2120 of the user having the reservation information transmitted thereto (step S2204). When the retrieval request signal is received (step S2204: YES), the reservation-time-slot acquiring unit 2104 acquires a reservation time slot for the specified attraction reserved by the user (step S2205). The wait-time acquiring unit 2105 acquires a wait-time of attractions other than the specified attraction (step S2206).

The retrieving unit 2106 retrieves an attraction that is available in a vacant time slot other than the reservation time zone (step S2207), and the transmitter 2103 transmits a retrieval result (step S2208), thereby terminating the processing based on this flowchart. When the retrieval request signal is not received at step S2204 (step S2204: NO), the processing based on this flowchart is terminated as it is.

As explained above, according to the theme park management system 2100 of the second embodiment, the theme park management apparatus 2110 reserves utilization of the specified attraction specified by the user and transmits a result to the communication terminal 2120 of the user. As a result, the user can make a reservation by just specifying the attraction that the user wants to use without individually making a reservation for utilization. At the time of reservation, consideration of the user exit time from the theme park, enables making a reservation for attraction use in a more appropriate time slot.

The theme park management apparatus 2110 further retrieves an attraction that is available during a vacant time slot. As a result, the user can effectively exploit the vacant time slots. In particular, considering the reservation time slot of the specified attraction enables utilization other attractions without missing a reservation time, thereby effectively maximizing the time spent in the theme park. At this time, by further considering the wait-time in real-time when the retrieval is requested, the retrieval of other attractions suiting the actual situation can be performed.

When plural attractions are specified, accepting specification of a reservation priority order enables generating reservation information complying with user request. When a path to the specified attraction is retrieved and a result is transmitted to the communication terminal 2120 of the user, the user can be more smoothly moved in the theme park.

### EXAMPLE 2

### Entire Structure of Theme Park Management System

Example 2 of the theme park management apparatus 2110 according to the second embodiment will now be explained. Here, an example of a theme park, a facility in each attraction in the theme park, a system configuration of a theme park management system, a hardware configuration of a management apparatus 501, a hardware configuration of a communication terminal 404, an attraction list, an attraction management file, a movement information file, and an attraction utilization history file according to Example 2 are as explained in Example 1, thereby herein omitting explanation thereof (see FIGS. 3 to 11).

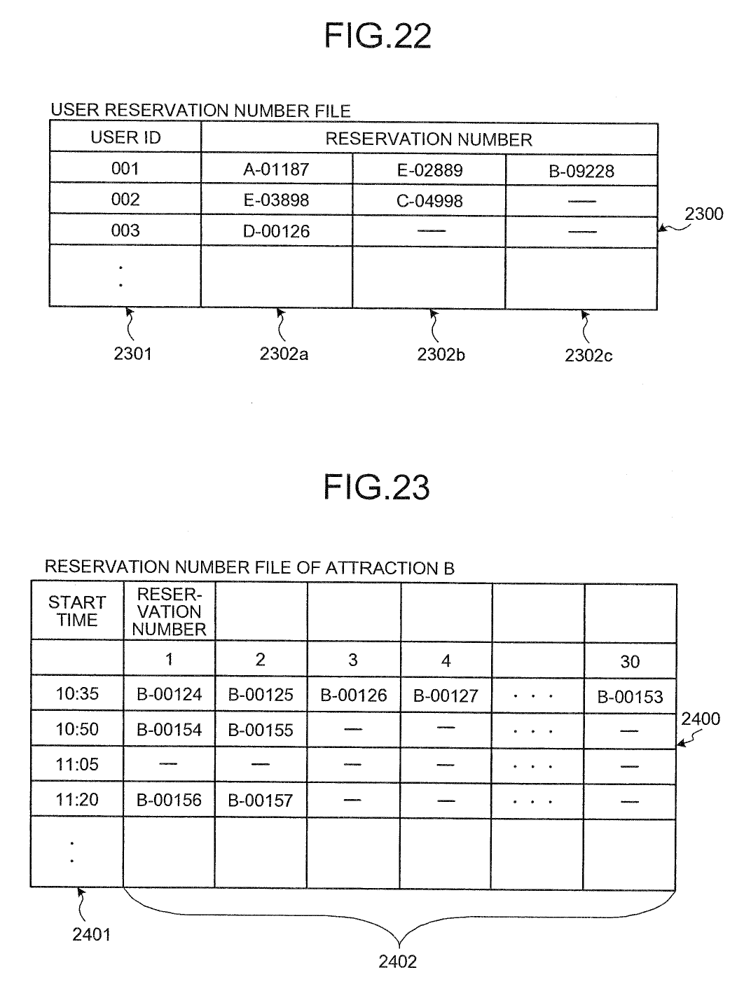

A user reservation number file will now be explained. FIG. 22 is a schematic of a user reservation number file. The management apparatus 501 accepts a reservation request for the attraction 401 from the user. A user can reduce wait-times to effectively exploit the time spent in the theme park by reserving the attraction 401 in advance. A user reservation number file 2300 includes a “user ID” area 2301 and a “reservation number” area 2302 (2302a to 2302c). The user ID area 2301 stores a user ID used as identification information identifying the communication terminal 404.

The reservation number area 2302 stores a reservation number of the attraction 401 with respect to each user. In the depicted example, the reservation number area 2302 can store three reservation numbers per user ID. That is because the number of attractions that can be reserved at a time is limited in terms of, for example, fairness of users. For example, a user having a user ID 001 reserves three attractions 401, and hence the user cannot make another reservation. On the other hand, users having user IDs 002 and 003 can make reservations in the remaining reservation frames. Each reservation number in the reservation number area 2302 is erased when the respective reservation start time passes (or when a given period of time elapses from the start time). As a result, a vacant frame is produced in the reservation number area 2302, and a user can reserve the next attraction.

An attraction reservation number file will now be explained. FIG. 23 is a schematic of an attraction reservation number file. An example depicted shows a reservation number file of the attraction B. An attraction reservation number file 2400 includes a “start time” area 2401 and a “reservation number” area 2402.

The start time area 2401 stores the operation start time of the attraction 401. The reservation number area 2402 stores a reservation number of a user having a reservation at each operation start time. In the depicted example, the reservation number area 2402 has 30 reservation frames, and a reservation number is stored in each reservation frame. Although all of the 30 reservation frames are filled for an operation having a start time at 10:35, some reservation frames are empty for operations having start times at 10:50 or later, and hence reservations can be made. Reservations may be allocated in the order of start time from earliest, or a start time may be specified according to a request of the user.

Each reservation number stored in the reservation number area 2402 is erased when a start time stored in the start time area 2401 passes (or when a given period of time elapses from the start time). At the same time, the same reservation number as the reservation number erased in the attraction reservation number file 2400 is retrieved from the user reservation number file 2300 and erased. A reservation for utilization is made at each start time of the attraction 401 in Example 2; however, a reservation for utilization may be made in a time slot having a fixed length. A reservation method of giving priority to utilize the attraction 401 to the user if the user goes to a reservation entrance gate 403 between 11:30 and 12:30 may be adopted, for example.

Although not depicted in particular, the theme park management apparatus includes a user management file storing a user ID and the number of persons in a group that the user carrying the communication terminal 404 with this user ID belongs to in association with each other. In this user management file, a profile (gender, age, relationship (family, friends), and etc.) of a group may be stored in association with each other. The user management file is required when a group of persons carries one communication terminal 404 as in Example 2, and it is not necessarily required when each user carries the communication terminal 404.

### Method of Acquiring Current Position of Communication Terminal 404

A method of calculating a current position of a user will now be explained. In this Example 2, a current position of a user can be acquired by using a GPS or a communicator 304. When using the GPS, GPS information received by the position acquiring unit 704 (see FIG. 7) is used to obtain the latitude/longitude of the communication terminal 404. Latitude/longitude information obtained by the communication terminal 404 is transmitted to the management apparatus 501.

When using the communicator 304, alternative GPS information transmitted from the communicator 304 is used to obtain current position information of the communication terminal 404. In this case, the current position information may be calculated by the management apparatus 501 or by the communication terminal 404. In any case, mutually transmitting the calculated information enables knowing the position of the communication terminal 404.

Here, because an example of the method of calculating a current position from the alternative GPS information is as explained in Example 1, explanation thereof is herein omitted (see FIG. 14).

### Theme Park Management Processing by Management Apparatus 501

The details of theme park management processing by the management apparatus 501 will now be explained. As explained above, the management apparatus 501 accepts a request for reserving the attraction 401 and a request for adjusting available time in a reservation time slot from a user. The management apparatus 501 uses, for example, managed data (see FIGS. 8 to 23) to execute the requested processing.

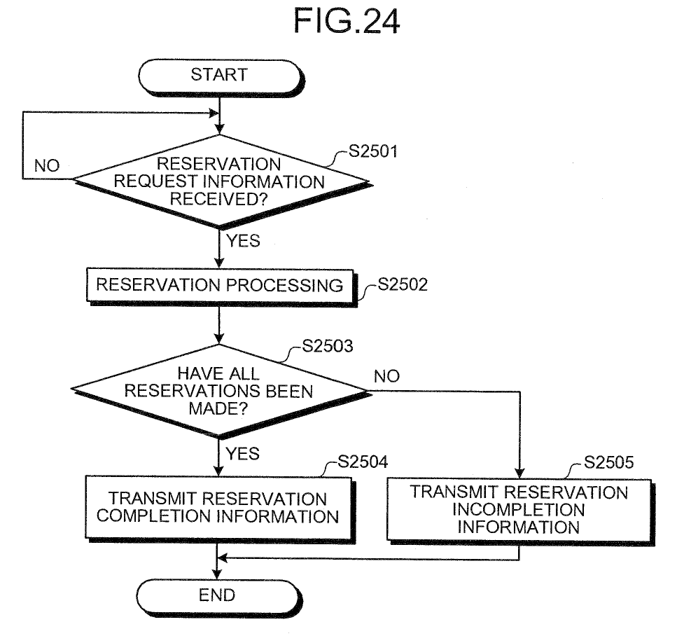

A procedure of reservation processing for the reservation request will be first explained. FIG. 24 is a flowchart of a procedure of the reservation processing for the reservation request. The management apparatus 501 waits until reservation request information for the attraction 401 from the communication terminal 404 is received (step S2501: NO loop). Here, the reservation request information includes a user ID specifying the user as a transmission source and information specifying the attraction 401 that the user wants to reserve (e.g., a name or location information of the attraction 401). An expected time that the user will exit the theme park is also included.

Upon receipt of the reservation request information (step S2501: YES), the management apparatus 501 executes the reservation processing based on the reservation request information (step S2502). Specifically, the management apparatus 501 judges whether the user reservation number file 2300 depicted in FIG. 22 has a vacant frame. When a vacant frame is present, the management apparatus 501 makes reference to the attraction reservation number file 2400 depicted in FIG. 23 to judge whether a vacant reservation frame is present within the time that the user finishes utilization before an expected time to exit the theme park. The time that the user finishes utilization before the expected time to exit the theme park is calculated by making reference to a time required to use the attraction 401 (see the utilization required time area 902 in FIG. 9) and location information of the attraction 401. When multiple users share the communication terminal 404, the management apparatus 501 judges whether vacant reservation frames corresponding to the number of all users using this communication terminal 404 are present.

When the vacant reservation frames are present, the reservation number corresponding to each user is written in the reservation number file 2300. The same number is also written in the vacant frame in the user reservation number file 2300. When a reservation priority order is specified with respect to the specified attraction 401 at this time, the reservation processing is executed starting from the attraction 401 having a high reservation priority level. When all the attractions 401 included in the reservation request information are successfully reserved (step S2503: YES), reservation completion information is transmitted to the communication terminal 404 of each user (step S2504), thereby terminating the processing based on this flowchart. The reservation completion information includes, for example, information indicating that the reservation of the specified attraction 401 has been completed, a reservation number has been assigned to the user, etc. The reservation number is stored in the communication terminal 404 and used, for example, to inquire whether the user is a reservation holder when the attraction 401 is utilized.

On the other hand, when not all of the attractions 401 can be reserved (step S2503: NO), reservation incompletion information is transmitted to the communication terminal 404 of each user (step S2505), thereby terminating the processing based on this flowchart. When the reservation cannot be made, this corresponds to a situation where the user specifies the attractions 401 exceeding the number of attractions 401 that can be reserved at one time, or a situation where a vacant reservation frame is not present for a time slot that the user finishes utilization before an expected time of exiting the theme park. The reservation incompletion information includes the reason for the incomplete reservation, a reservation number of an unachieved reservation, etc.

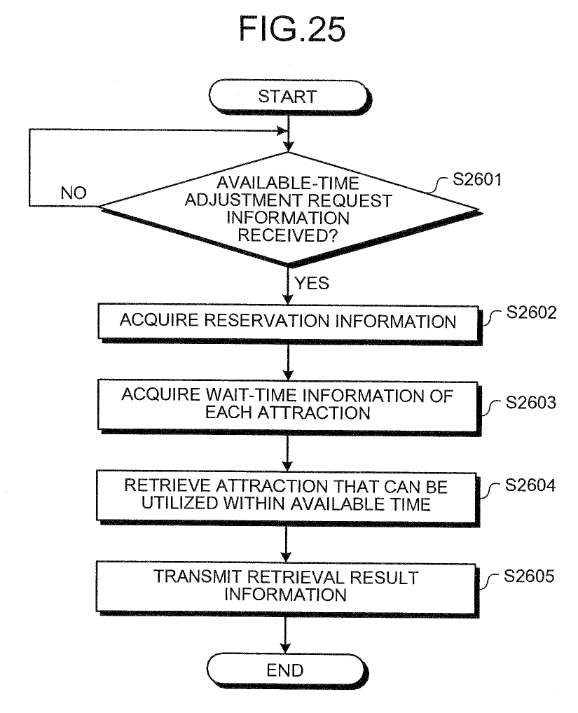

Retrieval processing with respect to a request for adjusting available time in a reservation time slot will now be explained. FIG. 25 is a flowchart of a procedure of retrieval processing with respect to a request for adjusting available time in a reservation time slot. The management apparatus 501 waits until available time adjustment request information of the attraction 401 from the communication terminal 404 of a user is received (step S2601: NO loop). Here, the available time adjustment request information includes a user ID specifying the user as a transmission source. Upon receipt of the vacant time adjustment request information (step S2601: YES), the management apparatus 501 acquires reservation information associated with the user ID (step S2602). The reservation information in this example is information concerning a reservation time slot of the attraction 401 reserved by the user. The reservation time slot means a time slot where the user is constrained when using the reserved attraction 401 including a utilization time of the attraction 401 or a moving time to the attraction 401.

The management apparatus 501 acquires wait-time information for each attraction 401 (step S2603). The wait-time information may be obtained by estimating a wait-time in real-time from the actual number of persons waiting (see the expected wait-time area 905 in FIG. 9) or by estimating a wait-time from past congestion (see the congestion (past) area 803 in FIG. 8), for example. A wait-time of the already utilized attraction 401 or the reserved attraction 401 is excluded from an acquisition target by making reference to the attraction utilization history file 1100 (see FIG. 11) or the user reservation number file 2300 (see FIG. 22).

The management apparatus 501 retrieves the attraction 401 that can be utilized by the user during the available time (step S2604). When the multiple attractions 401 are reserved, the attraction 401 that can be utilized during available time between the respective reservations is retrieved. At this time, retrieval is executed with consideration of the time required to move to the attraction 401 based on, for example, current position information of the user or position information of the attraction 401.

Retrieval result information is transmitted to the communication terminal 404 of the user (step S2605), and the processing based on this flowchart is terminated. The retrieval result information includes the attraction 401 that may be utilized during available time and an available time slot. A path to the retrieved attraction 401 is searched simultaneously with retrieval or in response to a request from the user having received the retrieval result, and guidance information may be transmitted to the communication terminal 404.

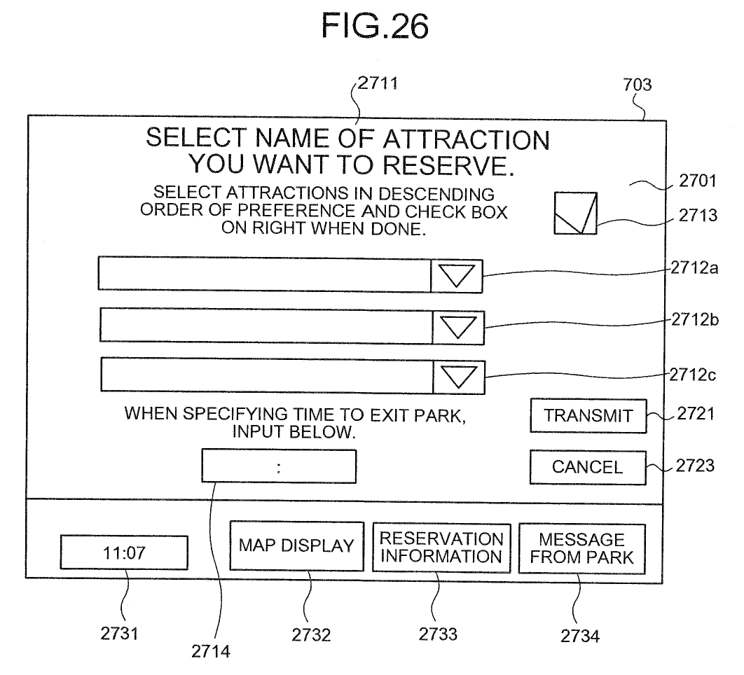

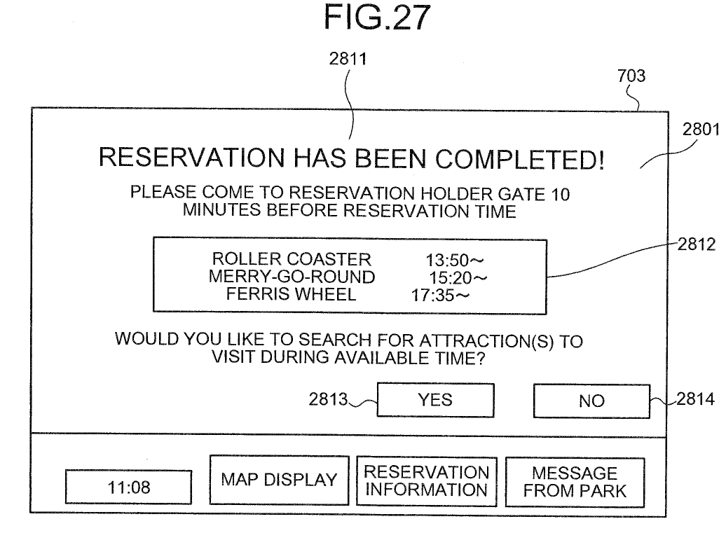

A processing request from a user serving as a trigger for the above-explained processing will now be explained. First, FIG. 26 is a schematic of a display unit of the communication terminal when issuing a reservation request (see the step S2501 in FIG. 24). A display unit 703 displays a reservation request screen 2701. The reservation request screen 2701 displays a message 2711 asking for a selection of the attraction 401 that is be reserved. An operation executed by a user in the following explanation is effected through a user operating unit 702.

The user selects desired attractions 401 from pulldown menus 2712 (2712a to 2712c). In Example 2, because the number of the attractions 401 that can be reserved at one time is three, only three pulldown menus 2712 are displayed. When a reservation priority order is set with respect to the attractions 401 selected by the user, the attractions 401 are sequentially selected starting from the attraction 401 having a higher priority level in the pulldown menus 2712, and a check box 2713 is checked.

When a park exit time is to be specified, a time of exiting the theme park is input in a time input section 2714. Then, a transmission button 2721 is pressed. When the reservation request is not to be made, a cancel button 2723 is pressed. As a result, reservation request information is transmitted to the management apparatus 501 from the communication terminal 404.

The display units 703 displays a current time indicator 2731, a map display button 2732, a reservation information button 2733, and a notification button 2734 besides the reservation request screen 2701. The current time indicator 2731 indicates a current time. When the map display button 2732 is pressed, a map of the theme park is displayed. When a position of the user (communication terminal 404) can be specified, the position may be superimposed on the map.

When the reservation information button 2733 is pressed, the display unit 703 displays reservation information of the attraction 401 reserved by the user. The reservation information is information including, for example, a name of, a reservation time, a reservation number, etc. for the reserved attraction 401. When the user confirms the contents of the reservation or utilizes the reserved attraction 401, the reservation information button 2733 is pressed to display the reservation information in the display unit 703. When the notification button 2734 is pressed, a notification from the theme park is displayed.

FIG. 27 is a schematic of the display unit of the communication terminal receiving the reservation completion information (step S2504 in FIG. 24). The display unit 703 displays a reservation completion screen 2801. The reservation completion screen 2801 displays a message 2821 indicating that the reservation has been completed. Reservation information 2822 including the reserved attraction 401 and a reservation time is also displayed.

When the user wants to retrieve the attraction 401 that is available during available time between the reservation slots, the user presses a “YES” button 2823. When retrieval is not required, the user presses a “NO” button 2824. When the “YES” button 2823 is pressed, the available time adjustment request information (see the step S2601 in FIG. 25) is transmitted to the management apparatus 501 from the communication terminal 404. Upon receiving this information, the management apparatus 501 retrieves the attraction 401.

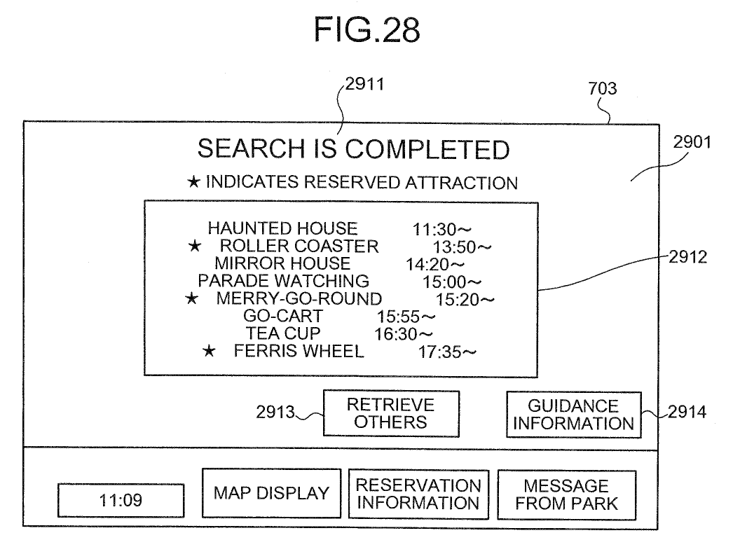

FIG. 28 is a schematic of the display unit of the communication terminal receiving the attraction retrieval result (step S2605 in FIG. 25). The display unit 703 displays a retrieval completion screen 2901. The retrieval completion screen 2901 displays a message 2911 indicating that retrieval has been completed. Retrieval result information 2912, including the retrieved attraction 401, an available time, etc., is also displayed.

When the user does not like the retrieval result, the user presses a “Retrieve Others” button 2913 to again transmit the available time adjustment request information to the management apparatus 501. If this retrieval result is used to utilize the attraction 401, a “Guidance Information” button 2914 is pressed, thereby obtaining information concerning guidance to the retrieved attraction 401.

As explained above, according to the theme park management system of Example 2, the management apparatus 501 reserves utilization of the attraction 401 specified by the user. As a result, the user can reserve the attraction 401 that the user wants to utilize without individually making a reservation for utilization. With consideration of the time at which the user will exit the theme park at the time a reservation is made, enables reservation of utilization in a more appropriate time slot.

The management apparatus 501 retrieves the attraction 401 that can be utilized during available time other than a reservation time slot. As a result, the user can effectively exploit the available time. In particular, the consideration of a reservation time of the specified attraction 401 enables utilizing other attractions 401 without missing the reservation time and also effectively exploiting the time that the user spends in the theme park. At this time, when a wait-time in real-time is considered at the instant of a retrieval request, other attractions 401 can be retrieved to further suit the actual situation.

When the multiple attractions 401 are specified, accepting specification of a reservation priority order enables generation of reservation information further meeting the user's request. When a path to the specified attraction 401 is searched for and a search result is transmitted to the communication terminal 404 of the user, the user can smoothly move in the theme park.

The theme park management method explained in the foregoing embodiments can be realized by a computer such as a personal computer and a workstation executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

1-20. (canceled)

21. A theme park management apparatus comprising:
a receiving unit that receives user specified information concerning a specified attraction that is an attraction among a plurality of attractions provided in a theme park and specified by a user of the theme park;
a detecting unit that detects a congestion level for each of the attractions;
a generating unit that generates reservation information including a reservation time for the specified attraction when the receiving unit receives the user specified information;
a determining unit that determines, based on the congestion level of each of the attractions excluding the specified attraction, a guidance point to which the user is guided and a privilege that becomes effective when the user follows guidance to the guidance point; and
a transmitting unit that transmits, to a communication terminal of the user, transmission information including the reservation information, the guidance point, and the privilege.

22. The theme park management apparatus according to claim 21, wherein the determining unit determines, from among the attractions, an attraction that has the congestion level that is lower than a predetermined level to be the guidance point.

23. The theme park management apparatus according to claim 21, wherein the determining unit determines a commercial facility in the theme park to be the guidance point.

24. The theme park management apparatus according to claim 21, wherein the determining unit determines preferential treatment at a commercial facility in the theme park to be the privilege.

25. The theme park management apparatus according to claim 21, wherein the determining unit determines preferential treatment at, among the attractions, an attraction that has the congestion level that is at least equal to a predetermined level to be the privilege.

26. The theme park management apparatus according to claim 21, wherein the determining unit further determines a valid period of the privilege.

27. The theme park management apparatus according to claim 21, further comprising:
an acquiring unit that acquires current position information of the communication terminal; and
a judging unit that judges, based on the current position information, whether the user is waiting to enter, among the attractions, an attraction that has the congestion level that is at least equal to a predetermined level, wherein
the transmitting unit transmits the transmission information to the communication terminal of the user based on a judgment at the judging unit.

28. The theme park management apparatus according to claim 27, further comprising:
a calculating unit that calculates, based on the current position information, a wait-time indicating an amount of time the user must wait to gain entrance to the attraction,
wherein the judging unit further judges whether the wait-time is at least equal to a predetermined time.

29. The theme park management apparatus according to claim 27, further comprising:
a calculating unit that calculates, based on the current position information, a headcount of people waiting to enter the attraction ahead of the user,
wherein the judging unit judges whether the headcount is at least equal to a predetermined number.

30. The theme park management apparatus according to claim 27, wherein
the judging unit judges whether the user is proceeding to, as a destination point, an attraction that has the congestion level that is at least equal to a predetermined level and is among the attractions, and
the transmitting unit transmits the transmission information to the communication terminal of the user based on a judgment at the judging unit.

31. The theme park management apparatus according to claim 21, further comprising:
an acquiring unit that acquires current position information concerning the communication terminal; and
a searching unit that uses the current position information to search for a path from a current position of the communication terminal to the guidance point, wherein
the transmitting unit transmits, to the communication terminal, the transmission information including the path found by the searching unit.

32. The theme park management apparatus according to claim 27, wherein
the acquiring unit includes:
an input unit into which identification information identifying the communication terminal is input, the identification information being received from the communication terminal by a plurality of communicators provided in the theme park, and
a detector that detects a reception time for each piece of the identification information upon receipt at the communicators, and
the current position information is calculated based on installation location information concerning each of the communicators and the reception time.

33. The theme park management apparatus according to claim 21, wherein
the receiving unit receives information concerning a time that the user will exit the theme park, and
the generating unit generates the reservation information based on the information concerning the time that the user will exit the theme park.

34. The theme park management apparatus according to claim 21, further comprising:
an acquiring unit that acquires a reservation time slot for the specified attraction; and
a retrieving unit that retrieves, from among the attractions, an attraction that can be utilized during available time outside the reservation time slot based on the reservation time slot and a wait-time for each of the attractions excluding the specified attraction,
wherein the transmitting unit transmits, to the communication terminal, the attraction retrieved by the retrieving unit.

35. The theme park management apparatus according to claim 34, wherein
the receiving unit receives, from the communication terminal, a retrieval request signal indicating a request for retrieval of an attraction from among the attractions excluding the specified attraction, and
the wait-time is the wait-time in real-time coinciding with reception of the retrieval request signal by the receiving unit.

36. The theme park management apparatus according to claim 21,
wherein the receiving unit receives a reservation priority order indicating a plurality of the specified attractions in order of priority, and
the generating unit generates the reservation information based on the reservation priority order.

37. The theme park management apparatus according to claim 34, further comprising:
a searching unit that searches for a path to the specified attraction,
wherein the transmitting unit transmits, to the communication terminal, information concerning the path found by the searching unit and the attraction retrieved by the retrieving unit.

38. A theme park management method comprising:
receiving user specified information concerning a specified attraction that is an attraction among a plurality of attractions provided in a theme park and specified by a user of the theme park;
detecting a congestion level for each of the attractions;
generating reservation information including a reservation time for the specified attraction when the receiving unit receives the user specified information;
determining, based on the congestion level of each of the attractions excluding the specified attraction, a guidance point to which the user is guided and a privilege that becomes effective when the user follows guidance to the guidance point; and
transmitting, to a communication terminal of the user, transmission information including the reservation information, the guidance point, and the privilege.

39. A computer-readable recording medium storing therein a theme park management program that causes a computer to execute:
receiving user specified information concerning a specified attraction that is an attraction among a plurality of attractions provided in a theme park and specified by a user of the theme park;
detecting a congestion level for each of the attractions;
generating reservation information including a reservation time for the specified attraction when the receiving unit receives the user specified information;
determining, based on the congestion level of each of the attractions excluding the specified attraction, a guidance point to which the user is guided and a privilege that becomes effective when the user follows guidance to the guidance point; and
transmitting, to a communication terminal of the user, transmission information including the reservation information, the guidance point, and the privilege.
